(19) United States
(12) Patent Application Publication
(10) Pub. No.: US 2026/0333281 A1
(43) Pub. Date: Oct. 22, 2026

(54) SURFACE PORTION INDICATION IN REFLECTOR-BASED SENSING FOR FAR FIELD AND NEAR FIELD

(71) Applicant: QUALCOMM Incorporated, San Diego, CA (US)

(72) Inventors: Min HUANG, Beijing (CN); Chao WEI, Beijing (CN); Hao XU, Beijing (CN)

(21) Appl. No.: 19/115,709

(22) PCT Filed: Dec. 1, 2022
(86) PCT No.: PCT/CN2022/135740

§ 371 Date: Mar. 26, 2025

(51) Int. Cl. H04W 64/00; H04B 7/04; H04W 72/0446; H04W 72/0453; H04W 72/231; H04W 76/20

(52) U.S. Cl. CPC H04W 64/00; H04B 7/04013; H04W 72/0446; H04W 72/0453; H04W 72/231; H04W 76/20

(57) ABSTRACT

Methods, systems, and devices for wireless communications are described. A RIS may receive first control information that indicates a sensing range and a wavelength of a sensing signal. The RIS may reflect the sensing signal toward a target object within the sensing range. The RIS may reflect the sensing signal using a portion of a reflective surface of the RIS based on a distance to the target object from the portion of the reflective surface and the wavelength of the sensing signal. The RIS may transmit second control information that indicates a center position of the portion of the reflective surface used to reflect the sensing signal.

### CROSS REFERENCE

This application is a 371 National Stage of PCT Application No. PCT/CN2022/135740, filed on Dec. 1, 2022, entitled “SURFACE PORTION INDICATION IN REFLECTOR-BASED SENSING FOR FAR FIELD AND NEAR FIELD”, and assigned to the assignee hereof. The disclosure of the prior Application is considered part of and is incorporated by reference into this Patent Application.

### FIELD OF TECHNOLOGY

The following relates to wireless communications, including surface portion indication in reflector-based sensing for far field and near field.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a reflective surface of a reconfigurable intelligent surface (RIS) may reflect signals from a UE or a network entity to detect positioning of a target object. In some examples, the target object may be in a near-field of the RIS, and a propagation path of the reflected signals may result in ambiguity in positioning of the target object.

### SUMMARY

The described techniques relate to improved methods, systems, devices, and apparatuses that support surface portion indication in reflector-based sensing for far field and near field. For example, the described techniques may enable a reconfigurable intelligent surface (RIS) to reflect a sensing signal from a network entity to a target object using a portion of a reflective surface, such that the target object is within the far field of the portion of the reflective surface, even if the target object is within the near field of the entire reflective surface. The network entity may indicate to the RIS a wavelength and a distance scope of a sensing signal. The distance scope may be a distance between the reflective surface and the target object. Based on the wavelength and the distance scope, the RIS may select a portion of the reflective surface to reflect the sensing signal. The network entity may transmit the sensing signal to the RIS, and the RIS may reflect the sensing signal using the selected portion of the reflected surface. The RIS may report to the network entity the portion of the reflected surface that was used to reflect the sensing signal. Based on the report and a reflection of the sensing signal, the network entity may identify a position of the target object.

A method for wireless communications at a RIS is described. The method may include receiving first control information that indicates a sensing range and a wavelength of a sensing signal, reflecting the sensing signal toward a target object within the sensing range using at least a portion of a reflective surface of the RIS based on a distance to the target object from the portion of the reflective surface and the wavelength of the sensing signal, and transmitting second control information that indicates a center position of at least the portion of the reflective surface used to reflect the sensing signal.

An apparatus for wireless communications at a RIS is described. The apparatus may include a processor, memory coupled with the processor, and instructions stored in the memory. The instructions may be executable by the processor to cause the apparatus to receive first control information that indicates a sensing range and a wavelength of a sensing signal, reflect the sensing signal toward a target object within the sensing range using at least a portion of a reflective surface of the RIS based on a distance to the target object from the portion of the reflective surface and the wavelength of the sensing signal, and transmit second control information that indicates a center position of at least the portion of the reflective surface used to reflect the sensing signal.

Another apparatus for wireless communications at a RIS is described. The apparatus may include means for receiving first control information that indicates a sensing range and a wavelength of a sensing signal, means for reflecting the sensing signal toward a target object within the sensing range using at least a portion of a reflective surface of the RIS based on a distance to the target object from the portion of the reflective surface and the wavelength of the sensing signal, and means for transmitting second control information that indicates a center position of at least the portion of the reflective surface used to reflect the sensing signal.

A non-transitory computer-readable medium storing code for wireless communications at a RIS is described. The code may include instructions executable by a processor to receive first control information that indicates a sensing range and a wavelength of a sensing signal, reflect the sensing signal toward a target object within the sensing range using at least a portion of a reflective surface of the RIS based on a distance to the target object from the portion of the reflective surface and the wavelength of the sensing signal, and transmit second control information that indicates a center position of at least the portion of the reflective surface used to reflect the sensing signal.

Some examples of the method, apparatuses, and non-transitory computer-readable medium described herein may further include operations, features, means, or instructions for determining the target object may be within a near field of the reflective surface and selecting the portion of the reflective surface such that the target object may be within a far field of the portion of the reflective surface.

Some examples of the method, apparatuses, and non-transitory computer-readable medium described herein may further include operations, features, means, or instructions for determining the target object may be within a far field of the reflective surface, where the sensing signal may be reflected using all of the reflective surface of the RIS.

In some examples of the method, apparatuses, and non-transitory computer-readable medium described herein, reflecting the sensing signal may include operations, features, means, or instructions for reflecting the sensing signal using a fraction of the reflective surface of the RIS, where the target object may be within a near field of the reflective surface and within a far field of the fraction of the reflective surface.

In some examples of the method, apparatuses, and non-transitory computer-readable medium described herein, the second control information indicates a fraction of the reflective surface and the center position of the fraction of the reflective surface.

In some examples of the method, apparatuses, and non-transitory computer-readable medium described herein, the second control information indicates the center position of the portion of the reflective surface as a positioning reference point.

In some examples of the method, apparatuses, and non-transitory computer-readable medium described herein, the second control information indicates an index of the portion from a set of multiple indexes for a set of multiple portions of the reflective surface.

In some examples of the method, apparatuses, and non-transitory computer-readable medium described herein, the second control information indicates a vertical center position and a horizontal center position of the portion of the reflective surface.

Some examples of the method, apparatuses, and non-transitory computer-readable medium described herein may further include operations, features, means, or instructions for receiving control signaling indicating a set of multiple time-frequency resources for sensing, where reflecting the sensing signal may be based on the control signaling.

In some examples of the method, apparatuses, and non-transitory computer-readable medium described herein, reflecting the sensing signal may include operations, features, means, or instructions for reflecting a first sensing signal, received via a first time-frequency resource of the set of multiple time-frequency resources, using a first portion of the reflective surface of the RIS and reflecting a second sensing signal, received via a second time-frequency resource of the set of multiple time-frequency resources, using a second portion of the reflective surface of the RIS.

In some examples of the method, apparatuses, and non-transitory computer-readable medium described herein, the second control information indicates a first center position of the first portion of the reflective surface and a second center position of the second portion of the reflective surface.

In some examples of the method, apparatuses, and non-transitory computer-readable medium described herein, the first time-frequency resource may be associated with sensing for a first sub-area that may be a first distance from the RIS, a first size of the first portion may be based on the first distance, and the second time-frequency resource may be associated with sensing for a second sub-area that may be a second distance from the RIS, and a second size of the second portion may be based on the second distance.

In some examples of the method, apparatuses, and non-transitory computer-readable medium described herein, the first sensing signal may be reflected using a first set of multiple first portions of the reflective surface, and the second sensing signal may be reflected using a second set of multiple second portions of the reflective surface.

Some examples of the method, apparatuses, and non-transitory computer-readable medium described herein may further include operations, features, means, or instructions for disabling another portion of the reflective surface of the RIS, where reflecting the sensing signal using at least the portion of the reflective surface may be based on disabling one or more other portions of the reflective surface.

Some examples of the method, apparatuses, and non-transitory computer-readable medium described herein may further include operations, features, means, or instructions for generating a flat low-gain beam at another portion of the reflective surface of the RIS, where reflecting the sensing signal using at least the portion of the reflective surface may be based on the flat low-gain beam at the other portion of the reflective surface.

Some examples of the method, apparatuses, and non-transitory computer-readable medium described herein may further include operations, features, means, or instructions for reflecting a second sensing signal toward the target object within the sensing range using at least a second portion of the reflective surface of the RIS based on a second distance to the target object from the second portion of the reflective surface and the wavelength of the second sensing signal, where the second control information indicates a second center position of the second portion of the reflective surface.

In some examples of the method, apparatuses, and non-transitory computer-readable medium described herein, the first control information may be received via a Radio Resource Control (RRC) message, a Medium Access Control (MAC) message, a downlink control information message, a sidelink control information message, or any combination thereof.

In some examples of the method, apparatuses, and non-transitory computer-readable medium described herein, the second control information may be transmitted via an RRC message, a MAC message, an uplink control information message, a sidelink control information message, or any combination thereof.

A method for wireless communications at a network entity is described. The method may include transmitting first control information that indicates a sensing range for a RIS and a wavelength of a sensing signal and transmitting a sensing signal for a target object within the sensing range, the sensing signal to be reflected by at least a portion of a reflective surface of the RIS based on a distance to the target object from the portion of the reflective surface and the wavelength of the sensing signal.

An apparatus for wireless communications at a network entity is described. The apparatus may include a processor, memory coupled with the processor, and instructions stored in the memory. The instructions may be executable by the processor to cause the apparatus to transmit first control information that indicates a sensing range for a RIS and a wavelength of a sensing signal and transmit a sensing signal for a target object within the sensing range, the sensing signal to be reflected by at least a portion of a reflective surface of the RIS based on a distance to the target object from the portion of the reflective surface and the wavelength of the sensing signal.

Another apparatus for wireless communications at a network entity is described. The apparatus may include means for transmitting first control information that indicates a sensing range for a RIS and a wavelength of a sensing signal and means for transmitting a sensing signal for a target object within the sensing range, the sensing signal to be reflected by at least a portion of a reflective surface of the RIS based on a distance to the target object from the portion of the reflective surface and the wavelength of the sensing signal.

A non-transitory computer-readable medium storing code for wireless communications at a network entity is described. The code may include instructions executable by a processor to transmit first control information that indicates a sensing range for a RIS and a wavelength of a sensing signal and transmit a sensing signal for a target object within the sensing range, the sensing signal to be reflected by at least a portion of a reflective surface of the RIS based on a distance to the target object from the portion of the reflective surface and the wavelength of the sensing signal.

Some examples of the method, apparatuses, and non-transitory computer-readable medium described herein may further include operations, features, means, or instructions for receiving second control information that indicates a center position of the portion of the reflective surface used to reflect the sensing signal and determining a position of the target object based on a reflection of the sensing signal and the center position of the portion of the reflective surface used to reflect the sensing signal.

In some examples of the method, apparatuses, and non-transitory computer-readable medium described herein, the second control information indicates the center position of the portion of the reflective surface as a positioning reference point.

In some examples of the method, apparatuses, and non-transitory computer-readable medium described herein, the second control information indicates an index of the portion from a set of multiple indexes for a set of multiple portions of the reflective surface.

Some examples of the method, apparatuses, and non-transitory computer-readable medium described herein may further include operations, features, means, or instructions for transmitting control signaling indicating a set of multiple time-frequency resources for sensing, where reflecting the sensing signal may be based on the control signaling.

In some examples of the method, apparatuses, and non-transitory computer-readable medium described herein, reflecting the sensing signal may include operations, features, means, or instructions for transmitting, via a first time-frequency resource of the set of multiple time-frequency resources, a first sensing signal to probe a first sub-area that may be a first distance from the RIS and transmitting, via a second time-frequency resource of the set of multiple time-frequency resources, a second sensing signal to probe a second sub-area that may be a second distance from the RIS.

Some examples of the method, apparatuses, and non-transitory computer-readable medium described herein may further include operations, features, means, or instructions for receiving first reflections of the first sensing signal from a first set of multiple first portions of the reflective surface and receiving second reflections of the second sensing signal from a second set of multiple second portions of the reflective surface.

Some examples of the method, apparatuses, and non-transitory computer-readable medium described herein may further include operations, features, means, or instructions for receiving a reflection of the sensing signal from the target object based on the sensing signal being reflected by at least the portion of the reflective surface toward the target object.

Some examples of the method, apparatuses, and non-transitory computer-readable medium described herein may further include operations, features, means, or instructions for receiving control signaling indicating sensing information for the target object based on a reflection of the sensing signal and determining a position of the target object based on the sensing information.

Some examples of the method, apparatuses, and non-transitory computer-readable medium described herein may further include operations, features, means, or instructions for transmitting a second sensing signal for the target object within the sensing range, the second sensing signal to be reflected by at least a second portion of the reflective surface of the RIS based on a second distance to the target object from the second portion of the reflective surface and the wavelength of the second sensing signal.

A method for wireless communications at a user equipment (UE) is described. The method may include receiving first control information indicating a set of multiple time-frequency resources for sensing, receiving a reflection of a sensing signal from a target object via a time-frequency resource of the set of multiple time-frequency resources, the sensing signal reflected by at least a portion of a reflective surface of a RIS, and receiving second control information that indicates a center position of the portion of the reflective surface used to reflect the sensing signal.

An apparatus for wireless communications at a UE is described. The apparatus may include a processor, memory coupled with the processor, and instructions stored in the memory. The instructions may be executable by the processor to cause the apparatus to receive first control information indicating a set of multiple time-frequency resources for sensing, receive a reflection of a sensing signal from a target object via a time-frequency resource of the set of multiple time-frequency resources, the sensing signal reflected by at least a portion of a reflective surface of a RIS, and receive second control information that indicates a center position of the portion of the reflective surface used to reflect the sensing signal.

Another apparatus for wireless communications at a UE is described. The apparatus may include means for receiving first control information indicating a set of multiple time-frequency resources for sensing, means for receiving a reflection of a sensing signal from a target object via a time-frequency resource of the set of multiple time-frequency resources, the sensing signal reflected by at least a portion of a reflective surface of a RIS, and means for receiving second control information that indicates a center position of the portion of the reflective surface used to reflect the sensing signal.

A non-transitory computer-readable medium storing code for wireless communications at a UE is described. The code may include instructions executable by a processor to receive first control information indicating a set of multiple time-frequency resources for sensing, receive a reflection of a sensing signal from a target object via a time-frequency resource of the set of multiple time-frequency resources, the sensing signal reflected by at least a portion of a reflective surface of a RIS, and receive second control information that indicates a center position of the portion of the reflective surface used to reflect the sensing signal.

### BRIEF DESCRIPTION OF THE DRAWINGS

FIG. 1 illustrates an example of a wireless communications system that supports surface portion indication in reflector-based sensing for far field and near field in accordance with one or more aspects of the present disclosure.

FIG. 2 illustrates an example of a wireless communication system that supports surface portion indication in reflector-based sensing for far field and near field in accordance with one or more aspects of the present disclosure.

FIG. 3 illustrates an example of a sensing diagram that supports surface portion indication in reflector-based sensing for far field and near field in accordance with one or more aspects of the present disclosure.

FIG. 4 illustrates an example of a distance diagram that supports surface portion indication in reflector-based sensing for far field and near field in accordance with one or more aspects of the present disclosure.

FIG. 5 illustrates an example of a process flow that supports surface portion indication in reflector-based sensing for far field and near field in accordance with one or more aspects of the present disclosure.

FIGS. 6 and 7 illustrate block diagrams of devices that support surface portion indication in reflector-based sensing for far field and near field in accordance with one or more aspects of the present disclosure.

FIG. 8 illustrates a block diagram of a communications manager that supports surface portion indication in reflector-based sensing for far field and near field in accordance with one or more aspects of the present disclosure.

FIG. 9 illustrates a diagram of a system including a device that supports surface portion indication in reflector-based sensing for far field and near field in accordance with one or more aspects of the present disclosure.

FIGS. 10 and 11 illustrate block diagrams of devices that support surface portion indication in reflector-based sensing for far field and near field in accordance with one or more aspects of the present disclosure.

FIG. 12 illustrates a block diagram of a communications manager that supports surface portion indication in reflector-based sensing for far field and near field in accordance with one or more aspects of the present disclosure.

FIG. 13 illustrates a diagram of a system including a device that supports surface portion indication in reflector-based sensing for far field and near field in accordance with one or more aspects of the present disclosure.

FIGS. 14 through 16 illustrate flowcharts showing methods that support surface portion indication in reflector-based sensing for far field and near field in accordance with one or more aspects of the present disclosure.

### DETAILED DESCRIPTION

A wireless communications system may implement a repeater or reflector, such as a reconfigurable intelligent surface (RIS), to provide a direct line-of-sight link for sensing. For example, the RIS may help to identify (and thus avoid) line-of-sight blockages, improve a sensing range of a network entity or UE, and provide additional reference points to detect positioning of an object. The RIS may be used to detect a target object which is very close to the RIS using near-field sensing or a target object which is very far from the RIS using far-field sensing. With communications signaling, a radio wave for far-field communications (e.g., a distance between the RIS and the target object exceeds a threshold) is considered planar, and the angle between each transmit antenna element and each receive antenna element is the same. For near-field communications signaling, the radio wave is considered non-planar, and the angles between a transmit antenna element and each receive antenna element are different. For near-field communication, a signal may be reflected by all portions of the reflective surface of the RIS to a UE simultaneously, as the propagation path of the signal may not affect data decoding. However, for sensing signaling, the signal cannot be reflected by all portions of the RIS to the same object simultaneously, as sensing may consider the propagation path and angle of reflection to the target object to detect a position of the target object.

A RIS may be configured to use a portion of the reflective surface of the RIS to reflect sensing signaling toward a target object, such that the target object is in a far-field of the portion of the reflective surface. For example, the target object may be in a near-field of the entire reflective surface of the RIS, but the RIS may use, for example, a quadrant of the reflective surface of the RIS to reflect sensing signaling, and the target object may be in a far-field of the quadrant of the reflective surface. A network entity may transmit control signaling indicating a distance scope for the RIS and a wavelength of the sensing signal. In some examples, the control signaling may configure multiple sets of radio resources for sensing. The RIS may use different sized portions of the reflective surface for the different radio resources. For example, the RIS may use the entire portion of the reflective surface for a first radio resource to perform far-field sensing for a first area, use a portion of the reflective surface (e.g., a quadrant of the reflective surface) for a second radio resource to perform far-field sensing for a second area, and use an even smaller portion of the reflective surface (e.g., a sixteenth of the reflective surface) for a third radio resource to perform far-field sensing for a third area. The RIS may report center positions of the used surface portions for each sensing signal radio resource to the network entity.

By indicating a portion of the reflective surface used, a RIS may support increased accuracy in sensing procedures. For example, a UE or a network entity that receives a reflected sensing signal from a RIS may perform more accurate measurements in detecting positioning of a target object. In addition, by specifying a portion of the reflective surface used, a RIS may support a broader coverage area (e.g., a near-field and a far-field of the reflective surface of the RIS).

Aspects of the disclosure are initially described in the context of wireless communications systems. Aspects of the disclosure are additionally described with reference to sensing diagrams, distance diagrams, and process flows. Aspects of the disclosure are further illustrated by and described with reference to apparatus diagrams, system diagrams, and flowcharts that relate to surface portion indication in reflector-based sensing for far field and near field.

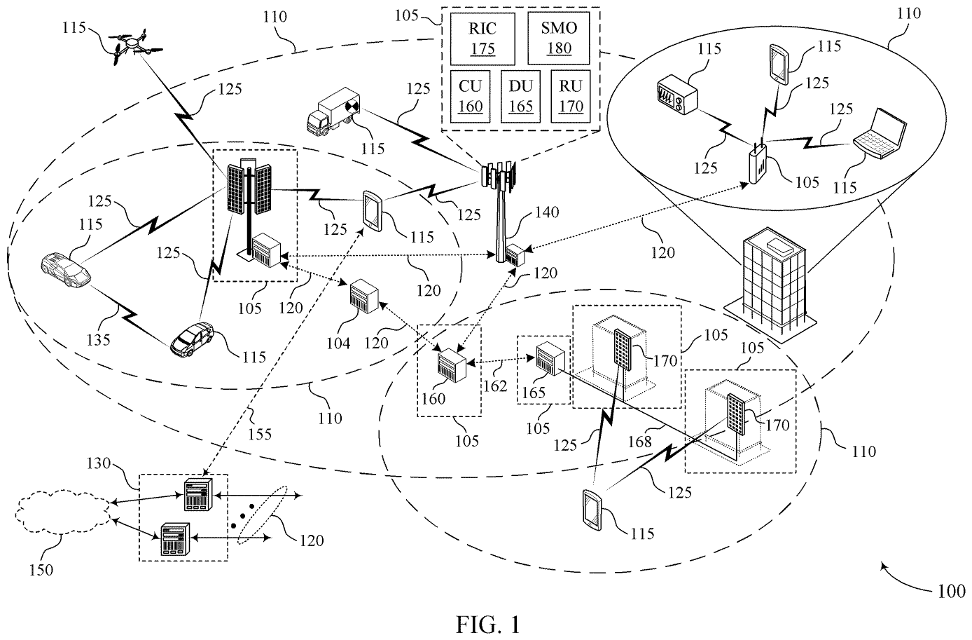

FIG. 1 illustrates an example of a wireless communications system 100 that supports surface portion indication in reflector-based sensing for far field and near field in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support surface portion indication in reflector-based sensing for far field and near field as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₙₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a sensing data processor (e.g., a UE 115 or a network entity 105) may perform sensing by transmitting sensing signals to detect positioning of objects. In some cases, the sensing data processor may experience various issues when performing. For example, a direct line of sight between the sensing data processor and the target object may be blocked. In some examples, a sensing range of the sensing data processor may be short and may not reach the target object. In some examples, the sensing data processor may have insufficient positioning reference points, and many candidate target positions may exist. In other examples, the sensing data processor may suffer from low spatial resolution, and the sensing data processor may be unable to recognize object shape, hand gestures, body gestures, or a combination thereof. In some examples, the sensing data processor may utilize a RIS to mitigate issues experienced when performing sensing.

A RIS may include a surface with many densely positioned reconfigurable meta-elements that may reflect (e.g., reflective RIS) or refract (e.g., transmissive RIS) electromagnetic waves to target directions, positions, objects, or any combination thereof. A RIS may be deployed for unmanned aerial vehicle (UAV) sensing, vehicle/pedestrian sensing, indoor sensing, outdoor to indoor sensing, or any combination thereof. In outdoor sensing applications, the RIS may be deployed at a building wall, a traffic board, or any other outdoor surface. In indoor sensing applications, the RIS may be deployed at a room wall, a ceiling, a window, or any other indoor surface.

By using a RIS, a sensing data processor may mitigate various issues experienced when performing sensing of target objects. For example, the sensing data processor may use the RIS to bypass a line-of-sight blockage, add a positioning reference point for detecting positioning of a target object, extend a sensing range of the sensing data processor, or improve spatial resolution for recognizing object shape, hand gestures, or body gestures.

A RIS may use formulas 0.62 \sqrt{(D³/λ)} or 2D²/λ to calculate a far-field threshold (e.g., the threshold between a near-field of a reflective surface of the RIS and a far field of the reflective surface of the RIS), where D is a width of an antenna array panel of the RIS and k is a wavelength of a radio wave reflected by the RIS. When the distance between the antenna array panel and a target object (e.g., a UE 115, a network entity 105, or another target object) is longer than the threshold, the radio wave may be planar (e.g., a wave front of the radio wave may be planar and perpendicular to the radio wave propagation direction). When the distance between the panel and the target object is shorter than the threshold, the radio wave may be non-planar, (e.g., the wave front may be spherical).

In a general case (e.g., both near-field and far-field), for an incident angle {θ_{i,n}} and a reflection angle {θ_{r,n}}, a reflection gain by the RIS, h, may be calculated by the formula:

$$h = {\sum }_{n = 0}^{N - 1} {e}^{j \frac{2 π ( ( {d}_{i , n} - {d}_{i , 0} ) + ( {d}_{r , n} - {d}_{r , 0} ) )}{λ}} \cdot {α}_{n} {e}^{j {ϕ}_{n}} ,$$

where n is the reflective coefficient of a meta-element. In a far-field, the formula for the reflection gain by the RIS may be simplified. For an incident angle θᵢ and a reflection angle θᵣ, the reflection gain by the RIS, h, may be calculated by the formula:

$$h = {\sum }_{n = 0}^{N - 1} {e}^{j \frac{2 π n d}{λ} ( si n {θ}_{i} + s i n {θ}_{r} )} \cdot {α}_{n} {e}^{j {ϕ}_{n}} .$$

When a RIS surface size is large relative to a coverage distance threshold, a communicating UE 115 or a sensing object within a range may be in the near-field of the RIS surface. The distance threshold between a reactive near field and a radiating near field may be 0.62 \sqrt{D³/λ}. The distance threshold between a radiating near field and a far field may be 2D²/λ. In some examples of near-field sensing, UEs or objects may be located in a room, a yard, or a square, where the RIS may be equipped on the wall and may partially or fully cover the wall. In such examples, served UEs or sensed objects may lie in the far-field or near-field of the RIS based on a distance between the served UEs or sensed objects and the RIS.

In accordance with examples described herein, a RIS in the wireless communications system 100 may receive (e.g., from a network entity 105) first control information that indicates a sensing range and a wavelength of a sensing signal. The RIS may reflect the sensing signal toward a target object within the sensing range. The RIS may reflect the sensing signal using a portion of a reflective surface of the RIS based on a distance to the target object from the portion of the reflective surface and the wavelength of the sensing signal. The RIS may transmit second control information that indicates a center position of the portion of the reflective surface used to reflect the sensing signal.

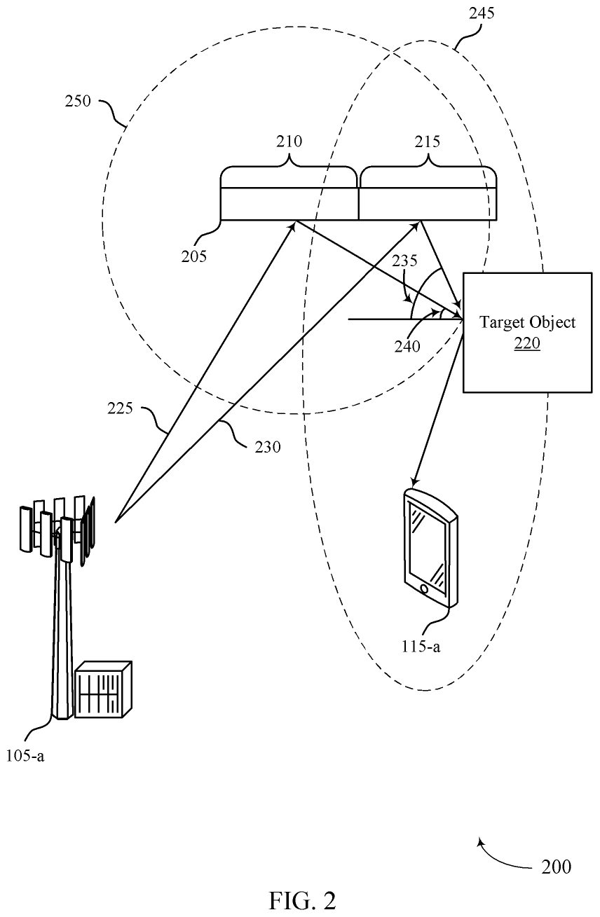

FIG. 2 illustrates an example of a wireless communications system 200 that supports surface portion indication in reflector-based sensing for far field and near field in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1.

The network entity 105-a may transmit a sensing signal to a RIS 205. The RIS 205 may reflect the sensing signal toward a target object 220 using a reflective surface (e.g., meta-surface, RIS surface) of the RIS 205. In some examples, the target object 220 may be in a near-field of the RIS 205. In such examples, the network entity 105-a may perform near-field sensing of the target object 220. Near-field sensing may differ from near-field communication. For example, in near-field communication, the network entity 105-a may transmit a data signal intended for a UE (e.g., UE 115-a) to the RIS 205. In near-field communication, the data signal may be reflected by all portions of the reflective surface to the UE simultaneously because data decoding may be performed without regard to propagation paths of the data signal.

In near-field sensing, however, the sensing signal may not be reflected by all portions of the reflective surface to the target object 220 simultaneously because sensing (e.g., positioning) of the target object 220 may be based on propagation paths of the sensing signal. That is, in the near-field, propagation from different portions of the reflective surface to the target object 220 may be regarded as different paths. In near-field sensing, a sensing data processor (e.g., a network entity in monostatic sensing, a UE in bi-static sensing, or a sensing server for any sensing type) may receive from the RIS 205 which portion of the reflective surface the sensing signal is reflected from.

In some examples, the target object 220 may be in a far-field of the RIS 205. In such examples, the reflected sensing signal may depart from the center of the reflective surface. In other examples, the target object may be in the near-field of the RIS 205. In such examples, the reflected sensing signal may depart from a portion of the reflective surface instead of the center of the reflective surface. For example, an effective incident sensing signal may come from a RIS surface edge instead of the center of the reflective surface. An effective incident sensing signal may come from a surface portion 210 instead of a surface portion 215.

Different incident directions of a sensing signal may result in different incident angles of the target object 220. For example, the network entity 105-a may transmit a sensing signal 225 to surface portion 210, which may result in an incident angle 240 of the target object 220. The network entity 105-a may transmit a sensing signal 230 to surface portion 215, which may result in an incident angle 235 of the target object 220. Due to variant target values of object radar cross sections for different incident directions (e.g., incident angle 240 is not the same as incident angle 235), reflected signal strengths from the different incident angles of the target object (each associated with a different RIS surface portion) may be unequal. For example, a reflected signal strength (e.g., a reflection power) of the sensing signal 225 (associated with surface portion 210) may be weaker than a reflected signal strength of the sensing signal 230 (associated with surface portion 215).

In some cases, the UE 115-a or the network entity 105-a may use a center of the RIS surface as a positioning reference point to determine positioning of the target object 220. However, when the target object 220 is in the near-field of the RIS surface, the difference between the determined positioning of the target object 220 and an actual positioning of the target object 220 may be non-negligible. In another example, the RIS 205 may use a surface portion 210 as a positioning reference point to determine a first positioning of the target object 220. The RIS 205 may use a surface portion 215 as a positioning reference point to determine a second positioning of the target object 220. The difference between the first positioning and the second positioning may be non-negligible when the target object 220 is in the near-field of the RIS 205. Accordingly, the UE 115-a or the network entity 105-a may select a positioning reference point that causes positioning error. For example, the UE 115-a or the network entity 105-a may select an incorrect candidate positioning circle or ellipse (e.g., a candidate positioning ellipse 245 or a candidate positioning circle 250) of the target object 220.

To support accurate positioning, the network entity 105-a may receive from the RIS 205 the exact positioning reference point of the RIS surface. The RIS may report the positioning reference point as the center of the surface portion used to reflect the sensing signal to the target object 220. In RIS-based sensing, the network entity 105-a may configure a sensing area (e.g., sensing distance scope) to the RIS 205. The sensing area may include both the far-field and the near-field of the reflective surface of the RIS 205. During RIS reflection beam sweeping, the RIS 205 may determine and report the center of the used surface portion (the whole RIS surface or a surface portion) based on a distance to the target object 220 from the RIS surface and a field type (far-field or near-field) of a target area (e.g., an area of the target object 220) for each reflection beam. In some examples, the network entity 105-a may be unable to determine RIS parameters and capabilities (e.g., whether and how to split the RIS surface), so the RIS 205 may determine a usage (e.g., surface split, beamforming) of the RIS surface instead of the network entity 105-a.

In some examples, the RIS 205 may use a formula to determine the distance of a reactive near field: 0.62 \sqrt{(D³/λ)}, where D is a length of the surface portion in one dimension. Additionally, or alternatively, the RIS 205 may use a formula to determine the distance of a radiating near field: 2D²/λ. A sensing signal carrier frequency may be 3.5 GHz. A wavelength, λ, of the sensing signal may be 8.6 cm. An inter-element interval may be 0.25 times the wavelength, λ. In some examples, quantity of elements (e.g., antennas) in the RIS 205 may be 128×128. In some examples, the network entity 105-a may configure the near field formula. The network entity 105-a may configure a distance scope (e.g., a sensing range) of the sensing area. The RIS 205 may calculate the near-field distances for the entire RIS surface, a quarter of the RIS surface, and a sixteenth of the RIS surface, respectively. A quarter of the RIS surface and a sixteenth of the RIS surface may be exemplary embodiments, and the RIS may use any other sized portion or fraction of the RIS surface not described herein.

The RIS 205 may divide the sensing area into one or more sub-areas by using the values of the near-field distances. The network entity 105-a may transmit and/or receive sensing signals. The RIS 205 may select the entire RIS surface or a sub-surface to reflect the sensing signal to each distance of the configured distance scope (e.g., sensing range) based on which sub-area the configured distance scope locates in. For example, the RIS 205 may select a sub-surface (or the entire RIS surface) such that the configured distance scope is within a far-field (e.g., satisfies a far-field distance threshold) of the selected sub-surface (or the entire RIS surface). In an example, if the length of the entire RIS surface is 2.7 m, the RIS 205 may determine that the reactive near-field is within 9.5 m of the RIS surface, the radiating near-field is between 9.5 m and 172.8 m of the RIS surface, and the far-field (e.g., the far-field distance threshold) is beyond 172.8 m. In another example, the RIS may use a sub-surface that is a quarter of the entire RIS surface, which may have a surface length of 1.35 m, and the RIS 205 may determine that the reactive near-field is within 1.35 m of the sub-surface, the radiating near-field is between 1.35 m and 3.3 m of the sub-surface, and the far-field is beyond 42.5 m of the sub-surface.

In some examples, the RIS 205 may reflect the sensing signal using one portion of the surface, and the RIS 205 may not use other surface portions to reflect the sensing signal. For example, the RIS 205 may use the surface portion 210 to reflect the sensing signal and may not use the surface portion 215 to reflect the sensing signal. In some examples, the RIS 205 may switch off the other surface portions (e.g., the surface portion 215), or the RIS 205 may generate an omni-low-gain beam at the other surface portions. The omni-low-gain beam may minimize the maximum signal power at all reflection angles. Accordingly, the RIS 205 may prevent reflected signals from the other surface portions from interfering with the reflected signal from the used surface portion.

In some examples, the RIS 205 may use multiple surface portions in multiple radio resources. The RIS 205 may report to the network entity 105-a center positions of the multiple surface portions. The sensing data processor (e.g., a network entity 105 in monostatic sensing, a UE 115 in bistatic sensing, or a sensing server for any sensing type) may map the sensing measurement results (e.g., an estimated delay or distance at each radio resource) with the center positions of the used surface portions, to estimate the position of the target object. For example, the estimated target object position may be the intersection of multiple candidate positioning circles or ellipses corresponding to the multiple surface portions. A candidate positioning circle 250 may correspond to the surface portion 210. The center of the candidate positioning circle 250 may be the center of surface portion 210, and the radius of the candidate positioning circle 250 may be the distance from the center of surface portion 210 to the target object 220. A candidate positioning ellipse 245 may correspond to the surface portion 215. A first focus point of the candidate positioning ellipse 245 may be the center of the surface portion 215, and a second focus point of the candidate positioning ellipse 245 may be the UE 115-a. In some examples, a sum of the distance from the center of the surface portion 215 to the target object 220 and the distance from the UE 115-a to the target object 220 may be twice the distance between the first focus point and the second focus point.

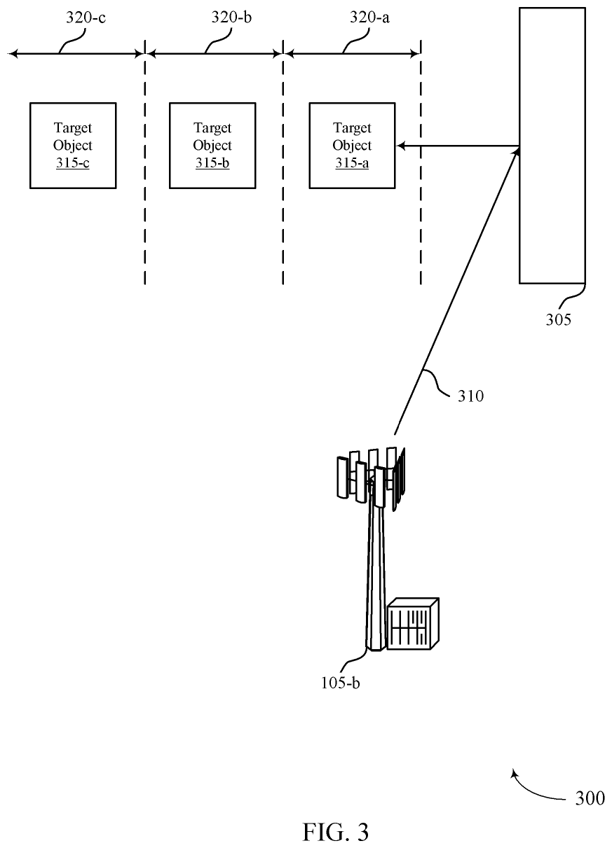

FIG. 3 illustrates an example of a sensing diagram 300 that supports surface portion indication in reflector-based sensing for far field and near field in accordance with one or more aspects of the present disclosure. The sensing diagram 300 may implement or may be implemented by aspects of the wireless communications system 100 or the wireless communications system 200. For example, the sensing diagram 300 may include a network entity 105-b, a RIS 305, and target objects 315, which may be examples of corresponding devices described with reference to FIGS. 1 and 2.

In some examples, the RIS 305 may determine whether a sensing sub-area 320 lies in a far field or a near field of a reflective surface (e.g., meta-surface, RIS surface) of the RIS 305 based on D (a length of the RIS surface, known by the RIS 305), λ (a wavelength of a sensing signal 310, configured by the network entity 105-b) and d (a distance between the RIS 305 and a sensing sub-area 320, selected by the RIS 305 based on a distance scope configured by the network entity 105-b). The RIS 305 may use a RIS surface portion corresponding to a sensing sub-area 320. The RIS 305 may report a center position of the used surface portion to the network entity 105-b.

The RIS 305 may use a function, f(D,λ), to calculate a far-field distance threshold (e.g., f(D, λ)=0.62 \sqrt{D³/λ}, or f(D, λ)=2D²/λ). In some examples, the RIS 305 may have a squared surface. If d≥f(D,λ), the RIS 305 may determine the sensed sub-area lies in a far field of the whole RIS surface. The RIS 305 may use the entire RIS surface to reflect the sensing signal 310 and may report the center of a 1×1 structure as the positioning reference point. If

$$f ( \frac{D}{2} , λ ) \leq d < f ( D , λ ) ,$$

the RIS 305 may determine the sensed sub-area lies in a near field of the entire RIS surface and a far field of a ¼ sub-surface of the RIS surface. The RIS 305 may report the center of the portion as an index (e.g., 1, 2, 3 or 4) of a 2×2 structure of the RIS surface as the positioning reference point. If

$$f ( \frac{D}{3} , λ ) \leq d < f ( \frac{D}{2} , λ ) ,$$

the RIS 305 may determine the sensed sub-area lies in a near field of the ¼ sub-surface and a far field of a 1/9 sub-surface of the RIS surface. The RIS 305 may report the center of the portion as an index (e.g., 1, 2, 3, 4, 5, 6, 7, 8, or 9) of a 3×3 structure of the RIS surface as the positioning reference point. The RIS 305 may follow a similar procedure for far-field distance thresholds

$$f ( \frac{D}{4} , λ ) , f ( \frac{D}{5} , λ ) ,$$

or any other far-field distance thresholds.

$$A \frac{1}{4}$$

sub-surface and a 1/9 sub-surface of the RIS surface may be exemplary examples, and the RIS may use other sized portions or other fractions of the RIS surface not described herein. A 2×2 structure and a 3×3 structure of the RIS surface may be exemplary examples, and the RIS may use other arrayed structures of the RIS surface not described herein. In some cases, a horizontal length of the RIS surface may be unequal to a vertical length of the RIS surface, and the RIS 305 may report a portion array that has a different row quantity and column quantity.

In some examples, the RIS 305 may be equipped on a wall of a building and may be configured to sense target objects 315 (e.g., UAVs) in the configured distance scope. The front distance scope may start at a distance

$$f ( \frac{D}{4} , λ )$$

and may end at a distance farther than f(D, λ). In some examples, the sensing area may contain three sensing sub-areas 320. A sensing sub-area 320-c may correspond to the far field of the entire RIS surface and may contain a target object 315-c. A sensing sub-area 320-b may correspond to the far field of the ¼ sub-surface and the near field of the entire surface and may contain a target object 315-b. A sensing sub-area 320-a may correspond to the far field of the 1/16 sub-surface and the near field of the ¼ sub-surface and may contain a target object 315-a.

The network entity 105-b may transmit sensing signals (e.g., sensing signal 310) in three sets of radio resources. In some examples, each set of radio resource may correspond to a different sensing sub-area. For example, for a first set of sensing signal radio resources, the RIS 305 may sweep reflection beams towards the sensing sub-area 320-c using the entire RIS surface. For a second set of sensing signal radio resources, the RIS 305 may sweep the reflection beams towards the sensing sub-area 320-b using one or more of the ¼ sub-surfaces of the RIS surface. For a third set of sensing signal radio resources, the RIS 305 may sweep the reflection beams towards the sensing sub-area 320-a using one or more of the 1/16 sub-surfaces of the RIS surface. The RIS 305 may report the center positions of the used surface portions (as positioning reference points) for each sensing signal radio resource to the network entity 105-b.

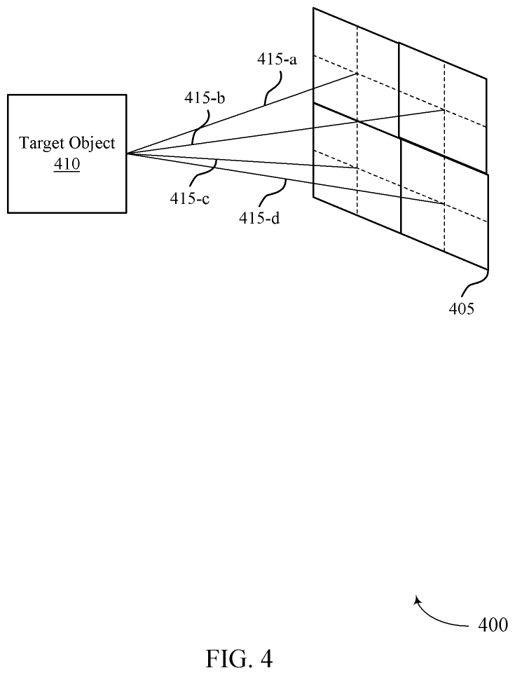

FIG. 4 illustrates an example of a distance diagram 400 that supports surface portion indication in reflector-based sensing for far field and near field in accordance with one or more aspects of the present disclosure. The distance diagram 400 may implement or may be implemented by aspects of the wireless communications system 100, the wireless communications system 200, or the sensing diagram 300. For example, the distance diagram 400 may include a RIS 405 and a target object 410, which may be examples of corresponding devices described with reference to FIGS. 1 through 3.

A RIS 405 may report surface portions of a reflective surface (e.g., meta-surface, RIS surface) of the RIS 405 that are used to reflect a sensing signal. In some examples, the RIS 405 may report a center of the used surface portion to a network entity. The RIS 405 may report a horizontal and a vertical distance (e.g., x, y) of the center position of the used surface portion relative to the center of the entire RIS surface for each sensing signal radio resource.

In some examples, a network entity may configure a sequence of candidate portion positions for the RIS to use to reflect a sensing signal. For example, the network entity may transmit control information indicating for the RIS to reflect the sensing signal using a first portion in a 1×1 structure, or any of a first portion through a fourth portion in a 2×2 structure, or any of a first portion through a ninth portion in a 3×3 structure. For each sensing signal radio resource, the RIS 405 may indicate an index of the sequence element associated with the used surface portion for each sensing signal resource.

After receiving a report of the RIS surface portion center from the RIS 405, a sensing data processor (e.g., a network entity in monostatic sensing, a UE in bi-static sensing, or a sensing server for any sensing type) may use the reported RIS surface portion center as a positioning reference point in estimating a position of the target object 410. For example, if a distance 415 between a surface portion center of the RIS and the target object 410 is estimated as d, the possible position of the target object is on a circle whose center is the reported surface portion center and whose radius is d. In some cases, using multiple distance estimates from multiple surface portion centers may indicate positioning of the target object 410.

For example, the sensing data processor may use a distance 415 between the RIS surface portion center and the target object 410 to determine a position of the target object 410. In a 4×4 structure, the sensing data processor may use a distance 415-a, a distance 415-b, a distance 415-c, or a distance 415-d, which may represent the distance between the RIS surface portion center and the target object 410. The sensing data processor may estimate that the position of the target object 410 is on a circle that has a center located at the reported RIS surface portion center and that has a radius that is equal to the corresponding distance 415. In some examples, the target object 410 may be located at an intersection of the different circles with radiuses equal to the different distances 415.

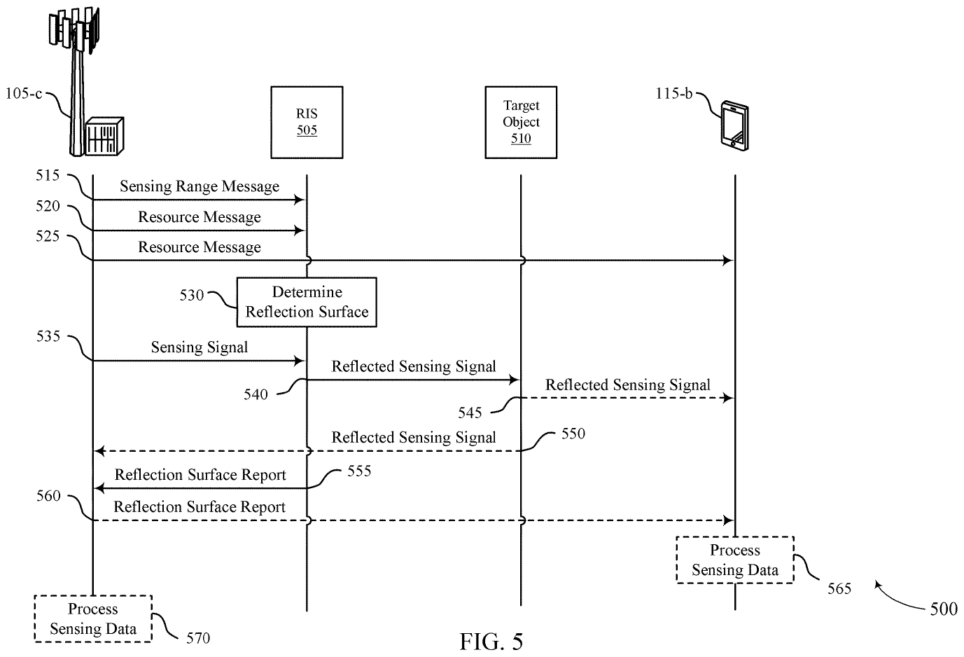

FIG. 5 illustrates an example of a process flow 500 that supports surface portion indication in reflector-based sensing for far field and near field in accordance with one or more aspects of the present disclosure. The process flow 500 may implement or may be implemented by aspects of the wireless communications system 100, the wireless communications system 200, the sensing diagram 300, or the distance diagram 400. For example, the process flow 500 may include a network entity 105-c, a RIS 505, a target object 510, and a UE 115-b, which may be examples of corresponding devices described with reference to FIGS. 1 through 4. In the following description of the process flow 500, operations between the network entity 105-c, the RIS 505, the target object 510, and the UE 115-b may be added, omitted, or performed in a different order (with respect to the exemplary order shown). Further, although some operations or signaling may be shown to occur at different times for discussion purposes, these operations may actually occur at the same time.

At 515, the network entity 105-c may transmit a sensing range message to the RIS 505 that indicates a sensing range (e.g., a distance scope). For example, the RIS 505 may receive first control information that indicates a sensing range and a wavelength of a sensing signal. The sensing range may include a distance from a RIS surface (e.g., reflective surface, meta-surface) of the RIS 505 to a sensing area (e.g., a sub-area). The target object 510 may be located in the sensing area. The sensing range message may include one or more sensing ranges for one or more time-frequency resources for sensing.

At 520, the network entity 105-c may transmit a resource message to the RIS 505 that indicates a wavelength of a sensing signal. For example, the RIS 505 may receive first control information that indicates a sensing range and a wavelength of a sensing signal. The resource message may include one or more wavelengths for one or more time-frequency resources for sensing. At 525, the network entity 105-c may transmit a resource message to the UE 115-b that indicates a plurality of time-frequency resources for sensing. For example, the UE 115-b may receive first control information that indicates a plurality of time-frequency resources for sensing.

At 530, the RIS 505 may determine a reflection surface to reflect the sensing signal. For example, the RIS 505 may select a portion (e.g., sub-surface) of a reflective surface of the RIS 505 based on a distance to the target object 510 from the portion of the RIS surface and the wavelength of the sensing signal. The RIS may select a distance value from the sensing range (e.g., the distance to the target object 510) and determine a field type (e.g., far-field, near-field). In some cases, the RIS 505 may determine that the target object is within a near-field of the reflective surface (e.g., the entire RIS surface), and the RIS 505 may select the portion of the reflective surface such that the target object 510 is within a far-field of the portion of the reflective surface. In other cases, the RIS 505 may determine that the target object 510 is within a far-field of the reflective surface, and the RIS 505 may determine to use all of the reflective surface.

At 535, the network entity 105-c may transmit the sensing signal for a target object 510 within the sensing range, the sensing signal to be reflected by at least a portion of a reflective surface of the RIS 505. At 540, the RIS 505 may reflect the sensing signal toward the target object 510 using at least a portion of a reflective surface of the RIS 505 based on a distance to the target object from the portion of the reflective surface and the wavelength of the sensing signal. For example, the RIS 505 may reflect the sensing signal using the reflection surface determined at step 530. In some examples, the RIS 505 may reflect the sensing signal using a fraction of the reflective surface of the RIS 505, where the target object 510 is within a near field of the reflective surface (e.g., the entire RIS surface) and a far field of the fraction of the reflective surface. At 545, the UE 115-b may receive a reflection of the sensing signal from the target object 510 via a time-frequency resource of the plurality of time-frequency resources, the sensing signal reflected by at least a portion of the reflective surface of the RIS 505 (e.g., in accordance with bi-static sensing). At 550, the network entity 105-c may receive a reflection of the sensing signal from the target object 510 via a time-frequency resource of the plurality of time-frequency resources, the sensing signal reflected by at least a portion of the reflective surface of the RIS 505 (e.g., in accordance with monostatic sensing).

At 555, the RIS 505 may transmit a reflection surface report to the network entity 105-c. For example, the RIS 505 may transmit second control information that indicates a center position of at least the portion of the reflective surface used to reflect the sensing signal. In some examples, the second control information may indicate a fraction of the reflective surface and the center position of the fraction of the reflective surface. In some examples, the second control information may indicate the center position of the portion of the reflective surface as a positioning reference point. In some examples, the second control information may indicate an index of the portion from a plurality of indexes for a plurality of portions of the reflective surface. In some cases, the second control information may indicate a vertical center position and a horizontal center position of the portion of the reflective surface. At 560, the network entity may relay the reflection surface report (e.g., the second control information) from the RIS 505 to the UE 115-b (e.g., in accordance with bi-static sensing). For example, the UE 115-b may receive second control information that indicates a center position of the portion of the reflective surface used to reflect the sensing signal.

At 565, the UE 115-b may process sensing data. For example, the UE 115-b may process the reflected sensing signal based on the received control information that indicates the portion of the reflective surface used to reflect the sensing signal. In some cases, the UE 115-b may determine a position of the target object 510 based on receiving one or more reflected sensing signals. At 570, the network entity 105-c may process sensing data. For example, the network entity 105-b may process the reflected sensing signal based on the received control information that indicates the portion of the reflective surface that was used to reflect the sensing signal. In some cases, the network entity 105-c may determine a position of the target object 510 based on receiving one or more reflected sensing signals.

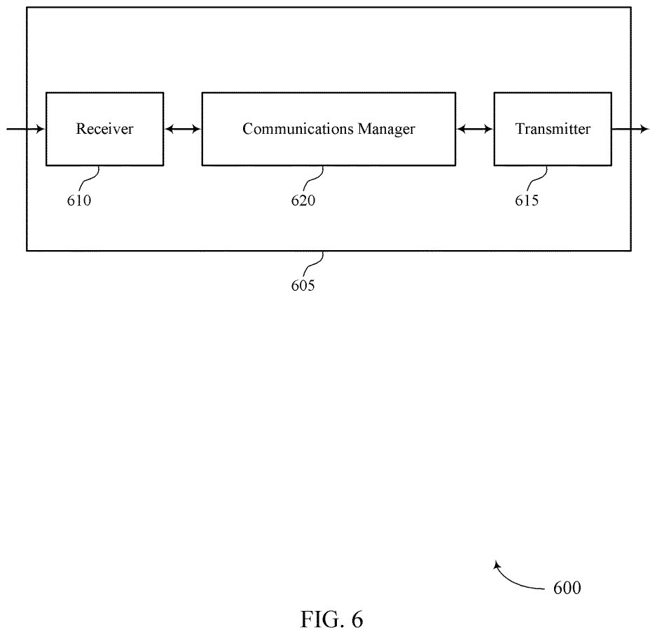

FIG. 6 illustrates a block diagram 600 of a device 605 that supports surface portion indication in reflector-based sensing for far field and near field in accordance with one or more aspects of the present disclosure. The device 605 may be an example of aspects of a RIS or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to surface portion indication in reflector-based sensing for far field and near field). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to surface portion indication in reflector-based sensing for far field and near field). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of surface portion indication in reflector-based sensing for far field and near field as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a RIS in accordance with examples as disclosed herein. For example, the communications manager 620 may be configured as or otherwise support a means for receiving first control information that indicates a sensing range and a wavelength of a sensing signal. The communications manager 620 may be configured as or otherwise support a means for reflecting the sensing signal toward a target object within the sensing range using at least a portion of a reflective surface of the RIS based on a distance to the target object from the portion of the reflective surface and the wavelength of the sensing signal. The communications manager 620 may be configured as or otherwise support a means for transmitting second control information that indicates a center position of at least the portion of the reflective surface used to reflect the sensing signal.

Additionally, or alternatively, the communications manager 620 may support wireless communications at a UE in accordance with examples as disclosed herein. For example, the communications manager 620 may be configured as or otherwise support a means for receiving first control information indicating a set of multiple time-frequency resources for sensing. The communications manager 620 may be configured as or otherwise support a means for receiving a reflection of a sensing signal from a target object via a time-frequency resource of the set of multiple time-frequency resources, the sensing signal reflected by at least a portion of a reflective surface of a RIS. The communications manager 620 may be configured as or otherwise support a means for receiving second control information that indicates a center position of the portion of the reflective surface used to reflect the sensing signal.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources by supporting greater accuracy in positioning reference points used in sensing procedures. The techniques described herein may reduce retransmission of sensing signals which may support reduced power consumption.

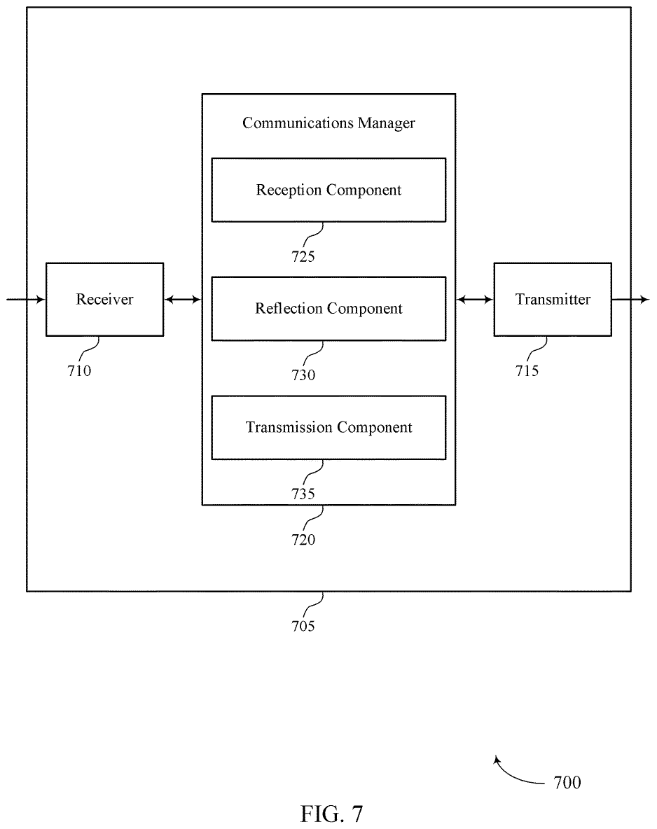

FIG. 7 illustrates a block diagram 700 of a device 705 that supports surface portion indication in reflector-based sensing for far field and near field in accordance with one or more aspects of the present disclosure. The device 705 may be an example of aspects of a device 605, a UE 115, or a RIS 205 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to surface portion indication in reflector-based sensing for far field and near field). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to surface portion indication in reflector-based sensing for far field and near field). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of surface portion indication in reflector-based sensing for far field and near field as described herein. For example, the communications manager 720 may include a reception component 725, a reflection component 730, a transmission component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a RIS in accordance with examples as disclosed herein. The reception component 725 may be configured as or otherwise support a means for receiving first control information that indicates a sensing range and a wavelength of a sensing signal. The reflection component 730 may be configured as or otherwise support a means for reflecting the sensing signal toward a target object within the sensing range using at least a portion of a reflective surface of the RIS based on a distance to the target object from the portion of the reflective surface and the wavelength of the sensing signal. The transmission component 735 may be configured as or otherwise support a means for transmitting second control information that indicates a center position of at least the portion of the reflective surface used to reflect the sensing signal.

Additionally, or alternatively, the communications manager 720 may support wireless communications at a UE in accordance with examples as disclosed herein. The reception component 725 may be configured as or otherwise support a means for receiving first control information indicating a set of multiple time-frequency resources for sensing. The reception component 725 may be configured as or otherwise support a means for receiving a reflection of a sensing signal from a target object via a time-frequency resource of the set of multiple time-frequency resources, the sensing signal reflected by at least a portion of a reflective surface of a RIS. The reception component 725 may be configured as or otherwise support a means for receiving second control information that indicates a center position of the portion of the reflective surface used to reflect the sensing signal.

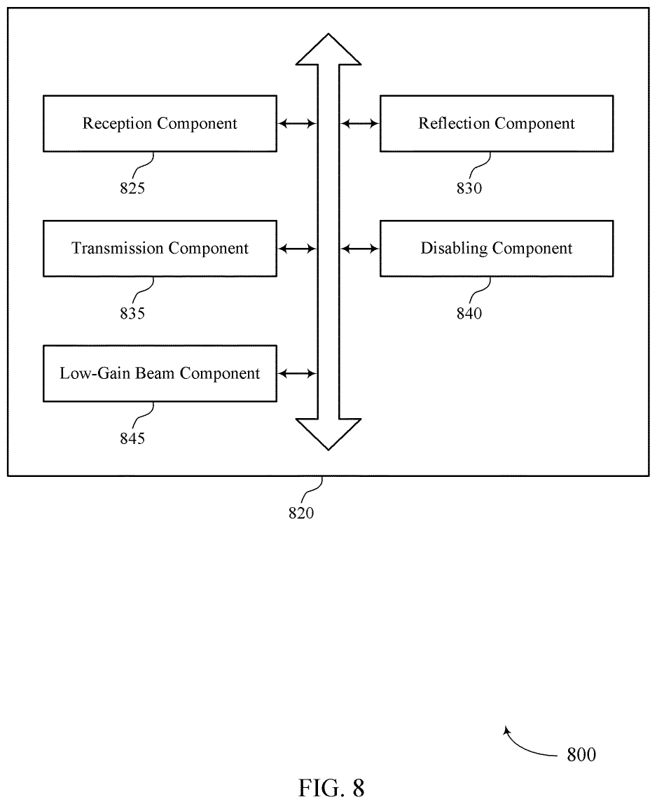

FIG. 8 illustrates a block diagram 800 of a communications manager 820 that supports surface portion indication in reflector-based sensing for far field and near field in accordance with one or more aspects of the present disclosure. The communications manager 820 may be an example of aspects of a communications manager 620, a communications manager 720, or both, as described herein. The communications manager 820, or various components thereof, may be an example of means for performing various aspects of surface portion indication in reflector-based sensing for far field and near field as described herein. For example, the communications manager 820 may include a reception component 825, a reflection component 830, a transmission component 835, a disabling component 840, a low-gain beam component 845, or any combination thereof. Each of these components may communicate, directly or indirectly, with one another (e.g., via one or more buses).

The communications manager 820 may support wireless communications at a RIS in accordance with examples as disclosed herein. The reception component 825 may be configured as or otherwise support a means for receiving first control information that indicates a sensing range and a wavelength of a sensing signal. The reflection component 830 may be configured as or otherwise support a means for reflecting the sensing signal toward a target object within the sensing range using at least a portion of a reflective surface of the RIS based on a distance to the target object from the portion of the reflective surface and the wavelength of the sensing signal. The transmission component 835 may be configured as or otherwise support a means for transmitting second control information that indicates a center position of at least the portion of the reflective surface used to reflect the sensing signal.

In some examples, the reflection component 830 may be configured as or otherwise support a means for determining the target object is within a near field of the reflective surface. In some examples, the reflection component 830 may be configured as or otherwise support a means for selecting the portion of the reflective surface such that the target object is within a far field of the portion of the reflective surface.

In some examples, the reflection component 830 may be configured as or otherwise support a means for determining the target object is within a far field of the reflective surface, where the sensing signal is reflected using all of the reflective surface of the RIS.

In some examples, to support reflecting the sensing signal, the reflection component 830 may be configured as or otherwise support a means for reflecting the sensing signal using a fraction of the reflective surface of the RIS, where the target object is within a near field of the reflective surface and within a far field of the fraction of the reflective surface.

In some examples, the second control information indicates a fraction of the reflective surface and the center position of the fraction of the reflective surface.

In some examples, the second control information indicates the center position of the portion of the reflective surface as a positioning reference point.

In some examples, the second control information indicates an index of the portion from a set of multiple indexes for a set of multiple portions of the reflective surface.

In some examples, the second control information indicates a vertical center position and a horizontal center position of the portion of the reflective surface.

In some examples, the reception component 825 may be configured as or otherwise support a means for receiving control signaling indicating a set of multiple time-frequency resources for sensing, where reflecting the sensing signal is based on the control signaling.

In some examples, to support reflecting the sensing signal, the reflection component 830 may be configured as or otherwise support a means for reflecting a first sensing signal, received via a first time-frequency resource of the set of multiple time-frequency resources, using a first portion of the reflective surface of the RIS. In some examples, to support reflecting the sensing signal, the reflection component 830 may be configured as or otherwise support a means for reflecting a second sensing signal, received via a second time-frequency resource of the set of multiple time-frequency resources, using a second portion of the reflective surface of the RIS.

In some examples, the second control information indicates a first center position of the first portion of the reflective surface and a second center position of the second portion of the reflective surface.

In some examples, the first time-frequency resource is associated with sensing for a first sub-area that is a first distance from the RIS. In some examples, a first size of the first portion is based on the first distance, and the second time-frequency resource is associated with sensing for a second sub-area that is a second distance from the RIS. In some examples, a second size of the second portion is based on the second distance.

In some examples, the first sensing signal is reflected using a first set of multiple first portions of the reflective surface, and the second sensing signal is reflected using a second set of multiple second portions of the reflective surface.

In some examples, the disabling component 840 may be configured as or otherwise support a means for disabling another portion of the reflective surface of the RIS, where reflecting the sensing signal using at least the portion of the reflective surface is based on disabling one or more other portions of the reflective surface.

In some examples, the low-gain beam component 845 may be configured as or otherwise support a means for generating a flat low-gain beam at another portion of the reflective surface of the RIS, where reflecting the sensing signal using at least the portion of the reflective surface is based on the flat low-gain beam at the other portion of the reflective surface.

In some examples, the reflection component 830 may be configured as or otherwise support a means for reflecting a second sensing signal toward the target object within the sensing range using at least a second portion of the reflective surface of the RIS based on a second distance to the target object from the second portion of the reflective surface and the wavelength of the second sensing signal, where the second control information indicates a second center position of the second portion of the reflective surface.

In some examples, the first control information is received via an RRC message, a MAC message, a downlink control information message, a sidelink control information message, or any combination thereof.

In some examples, the second control information is transmitted via an RRC message, a MAC message, an uplink control information message, a sidelink control information message, or any combination thereof.

Additionally, or alternatively, the communications manager 820 may support wireless communications at a UE in accordance with examples as disclosed herein. The reception component 825 may be configured as or otherwise support a means for receiving first control information indicating a set of multiple time-frequency resources for sensing. In some examples, the reception component 825 may be configured as or otherwise support a means for receiving a reflection of a sensing signal from a target object via a time-frequency resource of the set of multiple time-frequency resources, the sensing signal reflected by at least a portion of a reflective surface of a RIS. In some examples, the reception component 825 may be configured as or otherwise support a means for receiving second control information that indicates a center position of the portion of the reflective surface used to reflect the sensing signal.

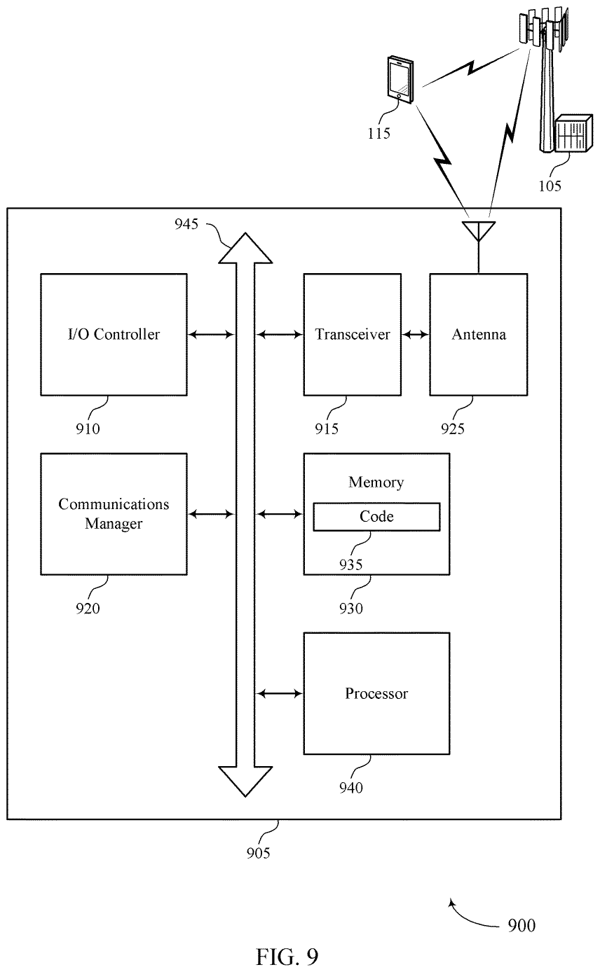

FIG. 9 illustrates a diagram of a system 900 including a device 905 that supports surface portion indication in reflector-based sensing for far field and near field in accordance with one or more aspects of the present disclosure. The device 905 may be an example of or include the components of a device 605, a device 705, a UE 115, or a RIS as described herein. The device 905 may communicate (e.g., wirelessly) with one or more network entities 105, one or more UEs 115, one or more RIS, or any combination thereof. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting surface portion indication in reflector-based sensing for far field and near field). For example, the device 905 or a component of the device 905 may include a processor 940 and memory 930 coupled with or to the processor 940, the processor 940 and memory 930 configured to perform various functions described herein.

The communications manager 920 may support wireless communications at a RIS in accordance with examples as disclosed herein. For example, the communications manager 920 may be configured as or otherwise support a means for receiving first control information that indicates a sensing range and a wavelength of a sensing signal. The communications manager 920 may be configured as or otherwise support a means for reflecting the sensing signal toward a target object within the sensing range using at least a portion of a reflective surface of the RIS based on a distance to the target object from the portion of the reflective surface and the wavelength of the sensing signal. The communications manager 920 may be configured as or otherwise support a means for transmitting second control information that indicates a center position of at least the portion of the reflective surface used to reflect the sensing signal.

Additionally, or alternatively, the communications manager 920 may support wireless communications at a first UE in accordance with examples as disclosed herein. For example, the communications manager 920 may be configured as or otherwise support a means for receiving first control information indicating a set of multiple time-frequency resources for sensing. The communications manager 920 may be configured as or otherwise support a means for receiving a reflection of a sensing signal from a target object via a time-frequency resource of the set of multiple time-frequency resources, the sensing signal reflected by at least a portion of a reflective surface of a reconfigurable intelligent surface. The communications manager 920 may be configured as or otherwise support a means for receiving second control information that indicates a center position of the portion of the reflective surface used to reflect the sensing signal.

By including or configuring the communications manager 920 in accordance with examples as described herein, the device 905 may support techniques for improved coordination between devices by supporting an increased capacity to detect positioning of target objects in a wireless communications system. The device 905 may improve utilization of processing power at a UE or a network entity by providing for more accurate positioning reference points for sensing procedures of target objects.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of surface portion indication in reflector-based sensing for far field and near field as described herein, or the processor 940 and the memory 930 may be otherwise configured to perform or support such operations.

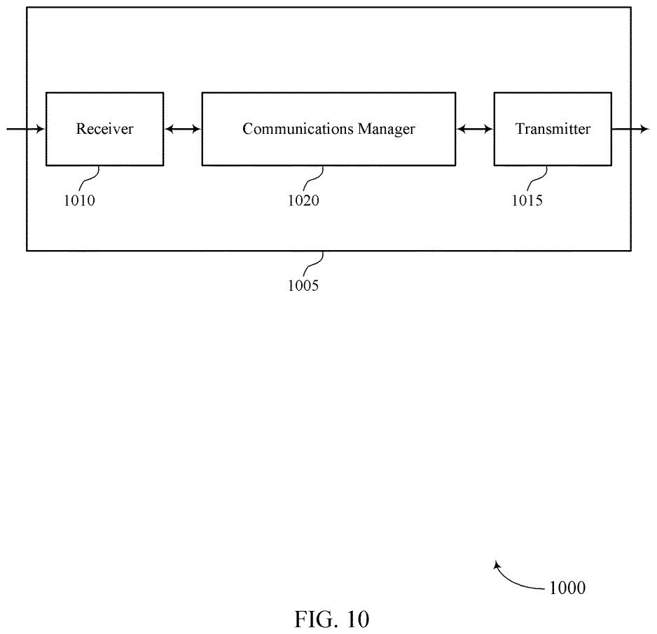

FIG. 10 illustrates a block diagram 1000 of a device 1005 that supports surface portion indication in reflector-based sensing for far field and near field in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of surface portion indication in reflector-based sensing for far field and near field as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting first control information that indicates a sensing range for a RIS and a wavelength of a sensing signal. The communications manager 1020 may be configured as or otherwise support a means for transmitting a sensing signal for a target object within the sensing range, the sensing signal to be reflected by at least a portion of a reflective surface of the RIS based on a distance to the target object from the portion of the reflective surface and the wavelength of the sensing signal.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources by supporting greater accuracy in positioning reference points used in sensing procedures. The techniques described herein may reduce retransmission of sensing signals which may support reduced power consumption.

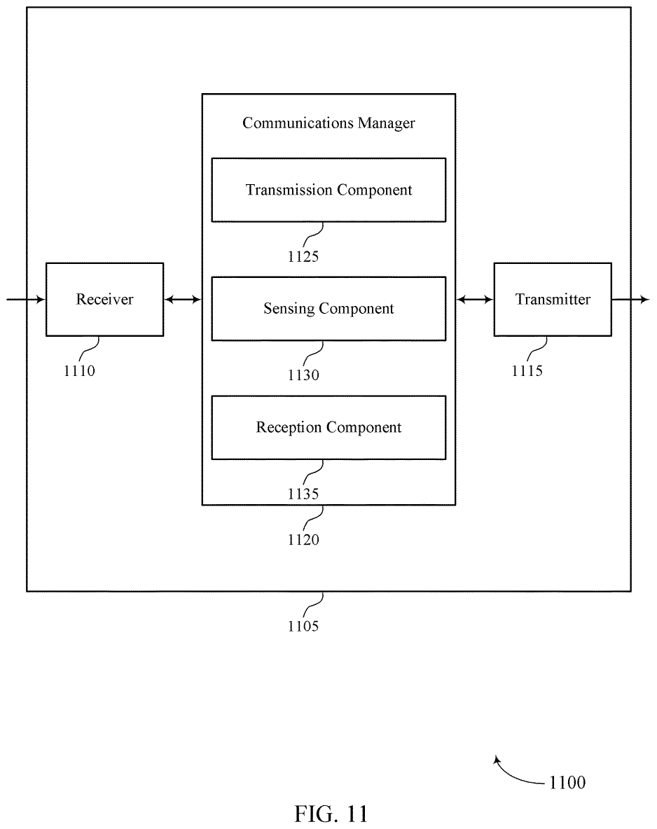

FIG. 11 illustrates a block diagram 1100 of a device 1105 that supports surface portion indication in reflector-based sensing for far field and near field in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of surface portion indication in reflector-based sensing for far field and near field as described herein. For example, the communications manager 1120 may include a transmission component 1125, a sensing component 1130, a reception component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The transmission component 1125 may be configured as or otherwise support a means for transmitting first control information that indicates a sensing range for a RIS and a wavelength of a sensing signal. The sensing component 1130 may be configured as or otherwise support a means for transmitting a sensing signal for a target object within the sensing range, the sensing signal to be reflected by at least a portion of a reflective surface of the RIS based on a distance to the target object from the portion of the reflective surface and the wavelength of the sensing signal.

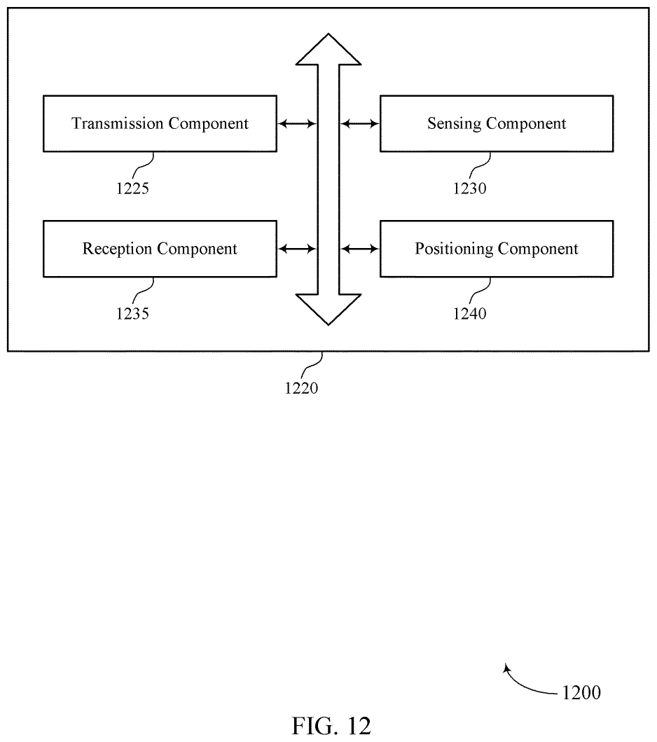

FIG. 12 illustrates a block diagram 1200 of a communications manager 1220 that supports surface portion indication in reflector-based sensing for far field and near field in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of surface portion indication in reflector-based sensing for far field and near field as described herein. For example, the communications manager 1220 may include a transmission component 1225, a sensing component 1230, a reception component 1235, a positioning component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The transmission component 1225 may be configured as or otherwise support a means for transmitting first control information that indicates a sensing range for a RIS and a wavelength of a sensing signal. The sensing component 1230 may be configured as or otherwise support a means for transmitting a sensing signal for a target object within the sensing range, the sensing signal to be reflected by at least a portion of a reflective surface of the RIS based on a distance to the target object from the portion of the reflective surface and the wavelength of the sensing signal.

In some examples, the reception component 1235 may be configured as or otherwise support a means for receiving second control information that indicates a center position of the portion of the reflective surface used to reflect the sensing signal. In some examples, the positioning component 1240 may be configured as or otherwise support a means for determining a position of the target object based on a reflection of the sensing signal and the center position of the portion of the reflective surface used to reflect the sensing signal.

In some examples, the second control information indicates the center position of the portion of the reflective surface as a positioning reference point.

In some examples, the second control information indicates an index of the portion from a set of multiple indexes for a set of multiple portions of the reflective surface.

In some examples, the transmission component 1225 may be configured as or otherwise support a means for transmitting control signaling indicating a set of multiple time-frequency resources for sensing, where reflecting the sensing signal is based on the control signaling.

In some examples, to support reflecting the sensing signal, the sensing component 1230 may be configured as or otherwise support a means for transmitting, via a first time-frequency resource of the set of multiple time-frequency resources, a first sensing signal to probe a first sub-area that is a first distance from the RIS. In some examples, to support reflecting the sensing signal, the sensing component 1230 may be configured as or otherwise support a means for transmitting, via a second time-frequency resource of the set of multiple time-frequency resources, a second sensing signal to probe a second sub-area that is a second distance from the RIS.

In some examples, the reception component 1235 may be configured as or otherwise support a means for receiving first reflections of the first sensing signal from a first set of multiple first portions of the reflective surface. In some examples, the reception component 1235 may be configured as or otherwise support a means for receiving second reflections of the second sensing signal from a second set of multiple second portions of the reflective surface.

In some examples, the reception component 1235 may be configured as or otherwise support a means for receiving a reflection of the sensing signal from the target object based on the sensing signal being reflected by at least the portion of the reflective surface toward the target object.

In some examples, the reception component 1235 may be configured as or otherwise support a means for receiving control signaling indicating sensing information for the target object based on a reflection of the sensing signal. In some examples, the positioning component 1240 may be configured as or otherwise support a means for determining a position of the target object based on the sensing information.

In some examples, the sensing component 1230 may be configured as or otherwise support a means for transmitting a second sensing signal for the target object within the sensing range, the second sensing signal to be reflected by at least a second portion of the reflective surface of the RIS based on a second distance to the target object from the second portion of the reflective surface and the wavelength of the second sensing signal.

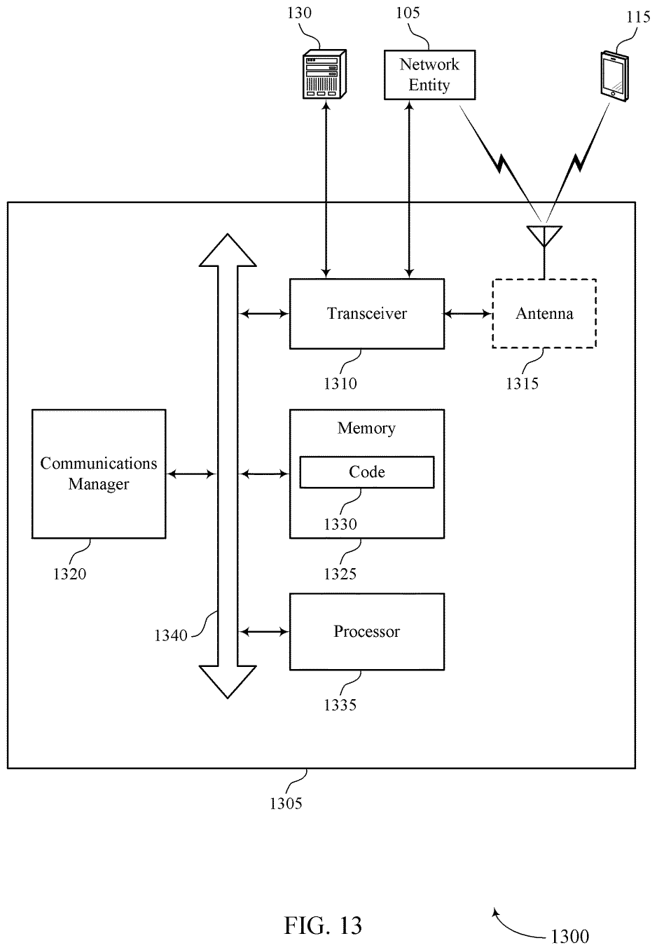

FIG. 13 illustrates a diagram of a system 1300 including a device 1305 that supports surface portion indication in reflector-based sensing for far field and near field in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting surface portion indication in reflector-based sensing for far field and near field). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting first control information that indicates a sensing range for a RIS and a wavelength of a sensing signal. The communications manager 1320 may be configured as or otherwise support a means for transmitting a sensing signal for a target object within the sensing range, the sensing signal to be reflected by at least a portion of a reflective surface of the RIS based on a distance to the target object from the portion of the reflective surface and the wavelength of the sensing signal.

By including or configuring the communications manager 1320 in accordance with examples as described herein, the device 1305 may support techniques for improved coordination between devices by supporting an increased capacity to detect positioning of target objects in a wireless communications system. The device 905 may improve utilization of processing power at a UE or a network entity by providing for more accurate positioning reference points for sensing procedures of target objects.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of surface portion indication in reflector-based sensing for far field and near field as described herein, or the processor 1335 and the memory 1325 may be otherwise configured to perform or support such operations.

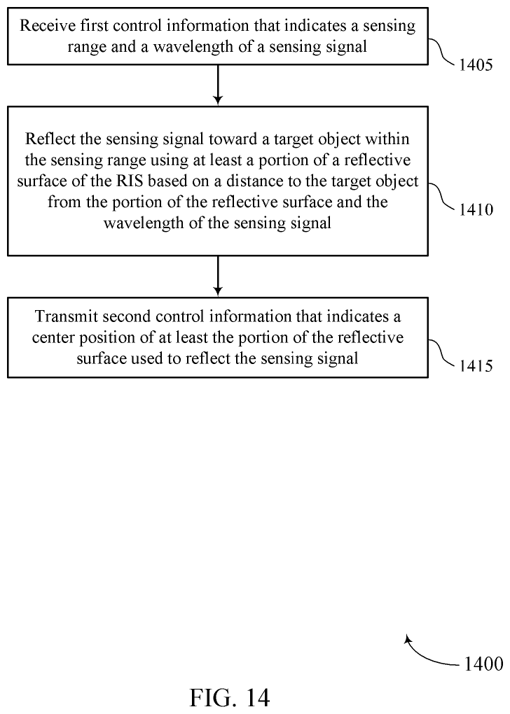

FIG. 14 illustrates a flowchart illustrating a method 1400 that supports surface portion indication in reflector-based sensing for far field and near field in accordance with one or more aspects of the present disclosure. The operations of the method 1400 may be implemented by a RIS or its components as described herein. For example, the operations of the method 1400 may be performed by a RIS as described with reference to FIGS. 1 through 9. In some examples, a RIS may execute a set of instructions to control the functional elements of the RIS to perform the described functions. Additionally, or alternatively, the RIS may perform aspects of the described functions using special-purpose hardware.

At 1405, the method may include receiving first control information that indicates a sensing range and a wavelength of a sensing signal. The operations of 1405 may be performed in accordance with examples as disclosed herein. In some examples, aspects of the operations of 1405 may be performed by a reception component 825 as described with reference to FIG. 8.

At 1410, the method may include reflecting the sensing signal toward a target object within the sensing range using at least a portion of a reflective surface of the RIS based on a distance to the target object from the portion of the reflective surface and the wavelength of the sensing signal. The operations of 1410 may be performed in accordance with examples as disclosed herein. In some examples, aspects of the operations of 1410 may be performed by a reflection component 830 as described with reference to FIG. 8.

At 1415, the method may include transmitting second control information that indicates a center position of at least the portion of the reflective surface used to reflect the sensing signal. The operations of 1415 may be performed in accordance with examples as disclosed herein. In some examples, aspects of the operations of 1415 may be performed by a transmission component 835 as described with reference to FIG. 8.

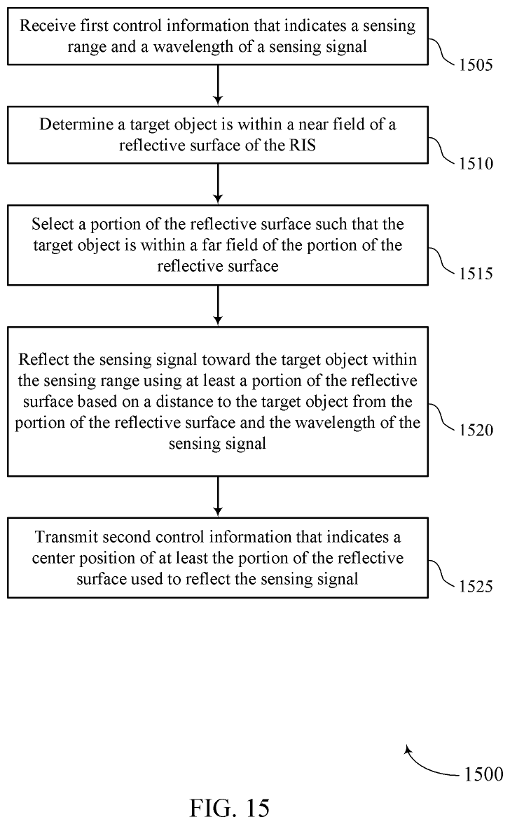

FIG. 15 illustrates a flowchart illustrating a method 1500 that supports surface portion indication in reflector-based sensing for far field and near field in accordance with one or more aspects of the present disclosure. The operations of the method 1500 may be implemented by a RIS or its components as described herein. For example, the operations of the method 1500 may be performed by a RIS as described with reference to FIGS. 1 through 9. In some examples, a RIS may execute a set of instructions to control the functional elements of the RIS to perform the described functions. Additionally, or alternatively, the RIS may perform aspects of the described functions using special-purpose hardware.

At 1505, the method may include receiving first control information that indicates a sensing range and a wavelength of a sensing signal. The operations of 1505 may be performed in accordance with examples as disclosed herein. In some examples, aspects of the operations of 1505 may be performed by a reception component 825 as described with reference to FIG. 8.

At 1510, the method may include determining a target object is within a near field of a reflective surface of the RIS. The operations of 1510 may be performed in accordance with examples as disclosed herein. In some examples, aspects of the operations of 1510 may be performed by a reflection component 830 as described with reference to FIG. 8.

At 1515, the method may include selecting the portion of the reflective surface such that the target object is within a far field of the portion of the reflective surface. The operations of 1515 may be performed in accordance with examples as disclosed herein. In some examples, aspects of the operations of 1515 may be performed by a reflection component 830 as described with reference to FIG. 8.

At 1520, the method may include reflecting the sensing signal toward a target object within the sensing range using at least a portion of the reflective surface based on a distance to the target object from the portion of the reflective surface and the wavelength of the sensing signal. The operations of 1520 may be performed in accordance with examples as disclosed herein. In some examples, aspects of the operations of 1520 may be performed by a reflection component 830 as described with reference to FIG. 8.

At 1525, the method may include transmitting second control information that indicates a center position of at least the portion of the reflective surface used to reflect the sensing signal. The operations of 1525 may be performed in accordance with examples as disclosed herein. In some examples, aspects of the operations of 1525 may be performed by a transmission component 835 as described with reference to FIG. 8.

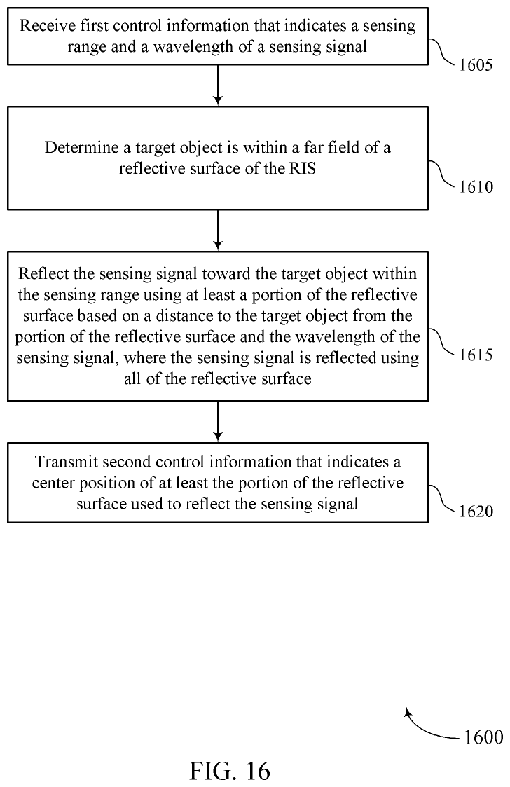

FIG. 16 illustrates a flowchart illustrating a method 1600 that supports surface portion indication in reflector-based sensing for far field and near field in accordance with one or more aspects of the present disclosure. The operations of the method 1600 may be implemented by a RIS or its components as described herein. For example, the operations of the method 1600 may be performed by a RIS as described with reference to FIGS. 1 through 9. In some examples, a RIS may execute a set of instructions to control the functional elements of the RIS to perform the described functions. Additionally, or alternatively, the RIS may perform aspects of the described functions using special-purpose hardware.

At 1605, the method may include receiving first control information that indicates a sensing range and a wavelength of a sensing signal. The operations of 1605 may be performed in accordance with examples as disclosed herein. In some examples, aspects of the operations of 1605 may be performed by a reception component 825 as described with reference to FIG. 8.

At 1610, the method may include determining a target object is within a far field of a reflective surface of the RIS. The operations of 1610 may be performed in accordance with examples as disclosed herein. In some examples, aspects of the operations of 1610 may be performed by a reflection component 830 as described with reference to FIG. 8.

At 1615, the method may include reflecting the sensing signal toward the target object within the sensing range using at least a portion of the reflective surface based on a distance to the target object from the portion of the reflective surface and the wavelength of the sensing signal, where the sensing signal is reflected using all of the reflective surface. The operations of 1615 may be performed in accordance with examples as disclosed herein. In some examples, aspects of the operations of 1615 may be performed by a reflection component 830 as described with reference to FIG. 8.

At 1620, the method may include transmitting second control information that indicates a center position of at least the portion of the reflective surface used to reflect the sensing signal. The operations of 1620 may be performed in accordance with examples as disclosed herein. In some examples, aspects of the operations of 1620 may be performed by a transmission component 835 as described with reference to FIG. 8.

The following provides an overview of aspects of the present disclosure:

Aspect 1: A method for wireless communications at a reconfigurable intelligent surface, comprising: receiving first control information that indicates a sensing range and a wavelength of a sensing signal; reflecting the sensing signal toward a target object within the sensing range using at least a portion of a reflective surface of the reconfigurable intelligent surface based at least in part on a distance to the target object from the portion of the reflective surface and the wavelength of the sensing signal; and transmitting second control information that indicates a center position of at least the portion of the reflective surface used to reflect the sensing signal.

Aspect 2: The method of aspect 1, further comprising: determining the target object is within a near field of the reflective surface; and selecting the portion of the reflective surface such that the target object is within a far field of the portion of the reflective surface.

Aspect 3: The method of any of aspects 1 through 2, further comprising: determining the target object is within a far field of the reflective surface, wherein the sensing signal is reflected using all of the reflective surface of the reconfigurable intelligent surface.

Aspect 4: The method of any of aspects 1 through 3, wherein reflecting the sensing signal comprises: reflecting the sensing signal using a fraction of the reflective surface of the reconfigurable intelligent surface, wherein the target object is within a near field of the reflective surface and within a far field of the fraction of the reflective surface.

Aspect 5: The method of any of aspects 1 through 4, wherein the second control information indicates a fraction of the reflective surface and the center position of the fraction of the reflective surface.

Aspect 6: The method of any of aspects 1 through 5, wherein the second control information indicates the center position of the portion of the reflective surface as a positioning reference point.

Aspect 7: The method of any of aspects 1 through 6, wherein the second control information indicates an index of the portion from a plurality of indexes for a plurality of portions of the reflective surface.

Aspect 8: The method of any of aspects 1 through 7, wherein the second control information indicates a vertical center position and a horizontal center position of the portion of the reflective surface.

Aspect 9: The method of any of aspects 1 through 8, further comprising: receiving control signaling indicating a plurality of time-frequency resources for sensing, wherein reflecting the sensing signal is based at least in part on the control signaling.

Aspect 10: The method of aspect 9, wherein reflecting the sensing signal comprises: reflecting a first sensing signal, received via a first time-frequency resource of the plurality of time-frequency resources, using a first portion of the reflective surface of the reconfigurable intelligent surface; and reflecting a second sensing signal, received via a second time-frequency resource of the plurality of time-frequency resources, using a second portion of the reflective surface of the reconfigurable intelligent surface.

Aspect 11: The method of aspect 10, wherein the second control information indicates a first center position of the first portion of the reflective surface and a second center position of the second portion of the reflective surface.

Aspect 12: The method of any of aspects 10 through 11, wherein the first time-frequency resource is associated with sensing for a first sub-area that is a first distance from the reconfigurable intelligent surface, a first size of the first portion is based at least in part on the first distance, and the second time-frequency resource is associated with sensing for a second sub-area that is a second distance from the reconfigurable intelligent surface, a second size of the second portion is based at least in part on the second distance.

Aspect 13: The method of any of aspects 10 through 12, wherein the first sensing signal is reflected using a first plurality of first portions of the reflective surface, and the second sensing signal is reflected using a second plurality of second portions of the reflective surface.

Aspect 14: The method of any of aspects 1 through 13, further comprising: disabling another portion of the reflective surface of the reconfigurable intelligent surface, wherein reflecting the sensing signal using at least the portion of the reflective surface is based at least in part on disabling one or more other portions of the reflective surface.

Aspect 15: The method of any of aspects 1 through 14, further comprising: generating a flat low-gain beam at another portion of the reflective surface of the reconfigurable intelligent surface, wherein reflecting the sensing signal using at least the portion of the reflective surface is based at least in part on the flat low-gain beam at the other portion of the reflective surface.

Aspect 16: The method of any of aspects 1 through 15, further comprising: reflecting a second sensing signal toward the target object within the sensing range using at least a second portion of the reflective surface of the reconfigurable intelligent surface based at least in part on a second distance to the target object from the second portion of the reflective surface and the wavelength of the second sensing signal, wherein the second control information indicates a second center position of the second portion of the reflective surface.

Aspect 17: The method of any of aspects 1 through 16, wherein the first control information is received via a Radio Resource Control message, a Medium Access Control message, a downlink control information message, a sidelink control information message, or any combination thereof.

Aspect 18: The method of any of aspects 1 through 17, wherein the second control information is transmitted via a Radio Resource Control message, a Medium Access Control message, an uplink control information message, a sidelink control information message, or any combination thereof.

Aspect 19: A method for wireless communications at a network entity, comprising: transmitting first control information that indicates a sensing range for a reconfigurable intelligent surface and a wavelength of a sensing signal; and transmitting a sensing signal for a target object within the sensing range, the sensing signal to be reflected by at least a portion of a reflective surface of the reconfigurable intelligent surface based at least in part on a distance to the target object from the portion of the reflective surface and the wavelength of the sensing signal.

Aspect 20: The method of aspect 19, further comprising: receiving second control information that indicates a center position of the portion of the reflective surface used to reflect the sensing signal; and determining a position of the target object based at least in part on a reflection of the sensing signal and the center position of the portion of the reflective surface used to reflect the sensing signal.

Aspect 21: The method of aspect 20, wherein the second control information indicates the center position of the portion of the reflective surface as a positioning reference point.

Aspect 22: The method of any of aspects 20 through 21, wherein the second control information indicates an index of the portion from a plurality of indexes for a plurality of portions of the reflective surface.

Aspect 23: The method of any of aspects 19 through 22, further comprising: transmitting control signaling indicating a plurality of time-frequency resources for sensing, wherein reflecting the sensing signal is based at least in part on the control signaling.

Aspect 24: The method of aspect 23, wherein reflecting the sensing signal comprises: transmitting, via a first time-frequency resource of the plurality of time-frequency resources, a first sensing signal to probe a first sub-area that is a first distance from the reconfigurable intelligent surface; and transmitting, via a second time-frequency resource of the plurality of time-frequency resources, a second sensing signal to probe a second sub-area that is a second distance from the reconfigurable intelligent surface.

Aspect 25: The method of aspect 24, further comprising: receiving first reflections of the first sensing signal from a first plurality of first portions of the reflective surface; and receiving second reflections of the second sensing signal from a second plurality of second portions of the reflective surface.

Aspect 26: The method of any of aspects 19 through 25, further comprising: receiving a reflection of the sensing signal from the target object based at least in part on the sensing signal being reflected by at least the portion of the reflective surface toward the target object.

Aspect 27: The method of any of aspects 19 through 26, further comprising: receiving control signaling indicating sensing information for the target object based at least in part on a reflection of the sensing signal; and determining a position of the target object based at least in part on the sensing information.

Aspect 28: The method of any of aspects 19 through 27, further comprising: transmitting a second sensing signal for the target object within the sensing range, the second sensing signal to be reflected by at least a second portion of the reflective surface of the reconfigurable intelligent surface based at least in part on a second distance to the target object from the second portion of the reflective surface and the wavelength of the second sensing signal.

Aspect 29: A method for wireless communications at a UE, comprising: receiving first control information indicating a plurality of time-frequency resources for sensing; receiving a reflection of a sensing signal from a target object via a time-frequency resource of the plurality of time-frequency resources, the sensing signal reflected by at least a portion of a reflective surface of a reconfigurable intelligent surface; and receiving second control information that indicates a center position of the portion of the reflective surface used to reflect the sensing signal.

Aspect 30: An apparatus for wireless communications at a reconfigurable intelligent surface, comprising a processor; memory coupled with the processor; and instructions stored in the memory and executable by the processor to cause the apparatus to perform a method of any of aspects 1 through 18.

Aspect 31: An apparatus for wireless communications at a reconfigurable intelligent surface, comprising at least one means for performing a method of any of aspects 1 through 18.

Aspect 32: A non-transitory computer-readable medium storing code for wireless communications at a reconfigurable intelligent surface, the code comprising instructions executable by a processor to perform a method of any of aspects 1 through 18.

Aspect 33: An apparatus for wireless communications at a network entity, comprising a processor; memory coupled with the processor; and instructions stored in the memory and executable by the processor to cause the apparatus to perform a method of any of aspects 19 through 28.

Aspect 34: An apparatus for wireless communications at a network entity, comprising at least one means for performing a method of any of aspects 19 through 28.

Aspect 35: A non-transitory computer-readable medium storing code for wireless communications at a network entity, the code comprising instructions executable by a processor to perform a method of any of aspects 19 through 28.

Aspect 36: An apparatus for wireless communications at a UE, comprising a processor; memory coupled with the processor; and instructions stored in the memory and executable by the processor to cause the apparatus to perform a method of any of aspects 29 through 29.

Aspect 37: An apparatus for wireless communications at a UE, comprising at least one means for performing a method of any of aspects 29 through 29.

Aspect 38: A non-transitory computer-readable medium storing code for wireless communications at a UE, the code comprising instructions executable by a processor to perform a method of any of aspects 29 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a reconfigurable intelligent surface, comprising:
receiving first control information that indicates a sensing range and a wavelength of a sensing signal;
reflecting the sensing signal toward a target object within the sensing range using at least a portion of a reflective surface of the reconfigurable intelligent surface based at least in part on a distance to the target object from the portion of the reflective surface and the wavelength of the sensing signal; and
transmitting second control information that indicates a center position of at least the portion of the reflective surface used to reflect the sensing signal.

2. The method of claim 1, further comprising:
determining the target object is within a near field of the reflective surface; and
selecting the portion of the reflective surface such that the target object is within a far field of the portion of the reflective surface.

3. The method of claim 1, further comprising:
determining the target object is within a far field of the reflective surface, wherein the sensing signal is reflected using all of the reflective surface of the reconfigurable intelligent surface.

4. The method of claim 1, wherein reflecting the sensing signal comprises:
reflecting the sensing signal using a fraction of the reflective surface of the reconfigurable intelligent surface, wherein the target object is within a near field of the reflective surface and within a far field of the fraction of the reflective surface.

5. The method of claim 1, wherein the second control information indicates at least one among:
a fraction of the reflective surface and the center position of the fraction of the reflective surface;
the center position of the portion of the reflective surface as a positioning reference point;
an index of the portion from a plurality of indexes for a plurality of portions of the reflective surface; and
a vertical center position and a horizontal center position of the portion of the reflective surface.

6-8. (canceled)

9. The method of claim 1, further comprising:
receiving control signaling indicating a plurality of time-frequency resources for sensing, wherein reflecting the sensing signal is based at least in part on the control signaling.

10. The method of claim 9, wherein reflecting the sensing signal comprises:
reflecting a first sensing signal, received via a first time-frequency resource of the plurality of time-frequency resources, using a first portion of the reflective surface of the reconfigurable intelligent surface; and
reflecting a second sensing signal, received via a second time-frequency resource of the plurality of time-frequency resources, using a second portion of the reflective surface of the reconfigurable intelligent surface.

11-13. (canceled)

14. The method of claim 1, further comprising:
disabling another portion of the reflective surface of the reconfigurable intelligent surface, wherein reflecting the sensing signal using at least the portion of the reflective surface is based at least in part on disabling one or more other portions of the reflective surface.

15. The method of claim 1, further comprising:
generating a flat low-gain beam at another portion of the reflective surface of the reconfigurable intelligent surface, wherein reflecting the sensing signal using at least the portion of the reflective surface is based at least in part on the flat low-gain beam at the other portion of the reflective surface.

16. The method of claim 1, further comprising:
reflecting a second sensing signal toward the target object within the sensing range using at least a second portion of the reflective surface of the reconfigurable intelligent surface based at least in part on a second distance to the target object from the second portion of the reflective surface and the wavelength of the second sensing signal, wherein the second control information indicates a second center position of the second portion of the reflective surface.

17. The method of claim 1, wherein the first control information and the second control information are received via a Radio Resource Control message, a Medium Access Control message, a downlink control information message, a sidelink control information message, or any combination thereof.

18. (canceled)

19. A method for wireless communications at a network entity, comprising:
transmitting first control information that indicates a sensing range for a reconfigurable intelligent surface and a wavelength of a sensing signal; and
transmitting a sensing signal for a target object within the sensing range, the sensing signal to be reflected by at least a portion of a reflective surface of the reconfigurable intelligent surface based at least in part on a distance to the target object from the portion of the reflective surface and the wavelength of the sensing signal.

20. The method of claim 19, further comprising:
receiving second control information that indicates a center position of the portion of the reflective surface used to reflect the sensing signal; and
determining a position of the target object based at least in part on a reflection of the sensing signal and the center position of the portion of the reflective surface used to reflect the sensing signal.

21. The method of claim 20, wherein the second control information indicates the center position of the portion of the reflective surface as a positioning reference point or an index of the portion from a plurality of indexes for a plurality of portions of the reflective surface.

22. (canceled)

23. The method of claim 19, further comprising:
transmitting control signaling indicating a plurality of time-frequency resources for sensing, wherein reflecting the sensing signal is based at least in part on the control signaling.

24. (canceled)

25. The method of claim 24, further comprising:
receiving first reflections of the first sensing signal from a first plurality of first portions of the reflective surface; and
receiving second reflections of the second sensing signal from a second plurality of second portions of the reflective surface.

26. The method of claim 19, further comprising:
receiving a reflection of the sensing signal from the target object based at least in part on the sensing signal being reflected by at least the portion of the reflective surface toward the target object.

27. The method of claim 19, further comprising:
receiving control signaling indicating sensing information for the target object based at least in part on a reflection of the sensing signal; and
determining a position of the target object based at least in part on the sensing information.

28. The method of claim 19, further comprising:
transmitting a second sensing signal for the target object within the sensing range, the second sensing signal to be reflected by at least a second portion of the reflective surface of the reconfigurable intelligent surface based at least in part on a second distance to the target object from the second portion of the reflective surface and the wavelength of the second sensing signal.

29. (canceled)

30. An apparatus for wireless communications at a reconfigurable intelligent surface, comprising:
a processor;
memory coupled with the processor; and
instructions stored in the memory and executable by the processor to cause the apparatus to:
receive first control information that indicates a sensing range and a wavelength of a sensing signal;
reflect the sensing signal toward a target object within the sensing range using at least a portion of a reflective surface of the reconfigurable intelligent surface based at least in part on a distance to the target object from the portion of the reflective surface and the wavelength of the sensing signal; and
transmit second control information that indicates a center position of at least the portion of the reflective surface used to reflect the sensing signal.
